(19) United States
(12) Patent Application Publication
(10) Pub. No.: US 2021/0270859 A1
(43) Pub. Date: Sep. 2, 2021

(54) AUTOSAMPLERS AND ANALYTIC SYSTEMS AND METHODS INCLUDING SAME

(71) Applicant: PerkinElmer Health Sciences, Inc., Waltham, MA (US)

(72) Inventor: Keith Ferrara, Stratford, CT (US)

(21) Appl. No.: 17/188,272

(22) Filed: Mar. 1, 2021

Related U.S. Application Data
(60) Provisional application No. 62/984,051, filed on Mar. 2, 2020.

(51) Int. Cl. G01N 35/00; G01N 35/10; B01L 3/00; G01N 1/14

(52) U.S. Cl. CPC G01N 35/00732; G01N 35/1011; B01L 3/502; G01N 2035/00752; G01N 1/14; G01N 2035/00801; G01N 2035/00881; G01N 35/00871

(57) ABSTRACT

An autosampler includes a carrier for receiving a plurality of sample containers each having a top end and a visible indicium. The visible indicia are located below a top plane defined by the top ends. The autosampler includes: an optical sensor configured to read the visible indicia and to generate a corresponding output signal, and having a line of sight; a controller configured to receive the output signal; and a sampling system to withdraw a sample from the sample containers. The autosampler is operative to relatively move the optical sensor and/or the carrier such that the line of sight intersects the visible indicium of a selected one of the sample containers, wherein the line of sight extends: downward from a height above the height of the top plane; at an oblique angle to the top plane; and through a gap between the selected sample container and an adjacent sample container.

### RELATED APPLICATION(S)

The present application claims the benefit of and priority from U.S. Provisional Patent Application No. 62/984,051, filed Mar. 2, 2020, the disclosure of which is incorporated herein by reference in its entirety.

### FIELD

The present technology relates to autosamplers and, more particularly, to autosamplers including optical sensors and/or RFID tags.

### BACKGROUND

Autosamplers are often used to selectively supply sample components to an analytical device such as a gas chromatograph. An autosampler may include a platter or other carrier and vials or other containers that are held in the carrier. Solid, liquid or gaseous samples are provided in the vials. The autosampler may deliver each vial to a prescribed position in the autosampler or the analytical device, for example, where an aliquot of the sample is removed from the vial. Alternatively, the autosampler may move a sampling device (e.g., an aspirating probe) to each vial to remove a sample from the vial.

Traceability of samples is extremely important in analytical laboratories. Some approaches to solve this problem include adding barcodes to sample containers that give each sample container a unique identification. The unique identification is logged into a database for tracking.

The sample containers or vials may be held in a tray or carrier, which is then loaded or mounted on the autosampler. Each carrier may have a different configuration, including the number and arrangement of the sample vials. The configuration and presence of a carrier is typically manually entered into a user interface of the autosampler.

### SUMMARY

According to some embodiments, an autosampler includes a carrier for receiving a plurality of sample containers. The sample containers each have a top end and a visible indicium. The top ends of the sample containers define a top plane. The visible indicia are located below the top plane. The autosampler further includes: an optical sensor configured to read the visible indicia and to generate an output signal corresponding thereto, the optical sensor having a line of sight; a controller configured to receive the output signal; and a sampling system to withdraw a sample from at least one of the sample containers. The autosampler is operative to move the optical sensor and/or the carrier relative to the other such that the line of sight intersects the visible indicium of a selected one of the sample containers, wherein the line of sight extends: downward from a height above the height of the top plane; at an oblique angle to the top plane; and through a gap between the selected sample container and an adjacent sample container.

In some embodiments, the carrier includes a plurality of seats, and the sample containers are disposed in respective ones of the seats.

In some embodiments, the visible indicium of each sample container is located on a sidewall of a top portion of the sample container.

In some embodiments, the oblique angle defined between the line of sight and the top plane is in the range of from about 30 to 60 degrees.

In some embodiments, the sample containers are configured in the carrier in an array including rows of the sample containers, and the rows each define a respective row axis.

According to some embodiments, the line of sight intersecting the visible indicium of the selected sample container lies in a line of sight plane that is orthogonal to the top plane. The autosampler is operative to move the optical sensor and/or the carrier relative to the other such that: the row axis of the row including the selected sample container extends at an oblique angle to the line of sight plane; and the line of sight intersecting the visible indicium of the selected sample container extends through a gap between the selected sample container and an adjacent sample container located in a row adjacent the row including the selected sample container.

In some embodiments, the oblique angle defined between the row axis of the row including the selected sample container and the line of sight plane is in the range of from about 30 to 60 degrees.

According to some embodiments, the autosampler is operative to move the optical sensor and/or the carrier relative to the other such that the line of sight intersecting the visible indicium of the selected sample container extends through a gap between the selected sample container and an adjacent sample container located in a row adjacent the row including the selected sample container.

In some embodiments, the autosampler is operative to move the optical sensor and/or the carrier relative to the other such that the line of sight intersecting the visible indicium of the selected sample container extends through a gap between the selected sample container and an adjacent sample container located in the row including the selected sample container.

In some embodiments, the carrier includes a plurality of seats, the sample containers are disposed in respective ones of the seats, and the gap is located over a seat in the row including the selected sample container that does not contain a sample container.

According to some embodiments, the sampling system includes a sampling probe configured to withdraw a sample from a sample container, and the autosampler is operative to position the sampling probe over the sample container when the line of sight of the optical sensor intersects the visible indicium of the selected sample container.

The autosampler may include a positioning system configured to move the optical sensor together with the sampling probe relative to the carrier.

The autosampler may include a mirror, wherein the line of sight extends from the visible indicium on the selected sample container to the mirror, and the mirror is configured to reflect an image of the visible indicium on the selected sample container to the optical sensor.

In some embodiments, the controller is configured to programmatically and automatically determine from an output signal of the optical sensor that a location in the carrier for holding a sample container does not contain a sample container.

According to some embodiments, the controller is configured to programmatically and automatically determine a type of the carrier from an output signal of the optical sensor.

In some embodiments, the controller is configured to programmatically and automatically identify each of the visible indicia.

The visible indicia may be barcodes.

In some embodiments, each sample container includes multiple copies of the visual indicium distributed about a circumference of the sample container.

According to some embodiments, the autosampler includes a reference marker. The controller is operative to determine whether a sample container is present in a target container receiving region of the carrier by: positioning the reference marker in the target container receiving region; acquiring an image of the container receiving region with the reference marker disposed in the target container receiving region; and determining from the acquired image whether the reference marker is obfuscated in the acquired image by a sample container disposed in the target container receiving region.

In some embodiments, the reference marker is a sampling probe forming a part of the sampling system and configured to withdraw a sample from a sample container.

According to some embodiments, a method for sampling includes providing a plurality of sample containers each having a top end and a visible indicium, and providing an autosampler. The autosampler includes a carrier holding the plurality of sample containers such that: the top ends of the sample containers define a top plane; and the visible indicia are located below the top plane. The autosampler further includes: an optical sensor configured to read the visible indicia and to generate an output signal corresponding thereto, the optical sensor having a line of sight; a controller configured to receive the output signal; and a sampling system to withdraw a sample from at least one of the sample containers. The method further includes using the autosampler, moving the optical sensor and/or the carrier relative to the other such that the line of sight intersects the visible indicium of a selected sample container, wherein the line of sight extends: downward from a height above the height of the top plane; at an oblique angle to the top plane; and through a gap between the selected sample container and an adjacent sample container. The method further includes: using the optical sensor, reading the visible indicia and generating an output signal corresponding thereto to the controller; and withdrawing a sample from the selected sample container.

In some embodiments, the method includes: providing an analytical instrument; and transferring the withdrawn sample to the analytical instrument.

According to some embodiments, the sample containers are configured in the carrier in an array including rows of the sample containers, and the rows each define a respective row axis, the line of sight intersecting the visible indicium of the selected sample container lies in a line of sight plane that is orthogonal to the top plane, and the method includes, using the autosampler, moving the optical sensor and/or the carrier relative to the other such that: the row axis of the row including the selected sample container extends at an oblique angle to the line of sight plane; and the line of sight intersecting the visible indicium of the selected sample container extends through a gap between the selected sample container and an adjacent sample container located in a row adjacent the row including the selected sample container.

According to some embodiments, an optical reader system includes a carrier for receiving a plurality of units, the units each having a top end and a visible indicium. The top ends of the units define a top plane. The visible indicia are located below the top plane.

The optical reader system further includes: an optical sensor configured to read the visible indicia and to generate an output signal corresponding thereto, the optical sensor having a line of sight; and a controller configured to receive the output signal. The optical reader system is operative to move the optical sensor and/or the carrier relative to the other such that the line of sight intersects the visible indicium of a selected one of the units, wherein the line of sight extends: downward from a height above the height of the top plane; at an oblique angle to the top plane; and through a gap between the selected unit and an adjacent unit.

According to some embodiments, a method for optical reading includes providing a plurality of units each having a top end and a visible indicium, and providing an optical reader system. The optical reader system includes a carrier holding the plurality of units such that: the top ends of the units define a top plane; and the visible indicia are located below the top plane. The optical reader system further includes: an optical sensor configured to read the visible indicia and to generate an output signal corresponding thereto, the optical sensor having a line of sight; and a controller configured to receive the output signal. The method further includes using the optical reader system, moving the optical sensor and/or the carrier relative to the other such that the line of sight intersects the visible indicium of a selected unit, wherein the line of sight extends: downward from a height above the height of the top plane; at an oblique angle to the top plane; and through a gap between the selected unit and an adjacent unit. The method further includes using the optical sensor, reading the visible indicia and generating an output signal corresponding thereto to the controller.

According to some embodiments, an autosampler includes a platform that defines a plurality of sample carrier positions; at least one sample carrier that is mounted on the platform in one of the plurality of sample carrier positions, the at least one sample carrier having an RFID tag thereon and being configured to receive a plurality of sample containers; an RFID reader that is configured to be moved between the plurality of sample carrier positions and configured to receive a signal from the RFID tag on the carrier when the carrier is positioned at one of the one or more sample carrier positions; and a sampling system to enable the withdrawal of a sample from at least one of the sample containers.

In some embodiments, the autosampler includes a scanning unit having the RFID reader mounted thereon. The scanning unit is configured to move the RFID reader along an X-axis to the plurality of sample carrier positions such that the RFID reader is configured to receive a signal from the at least one RFID tag on the at least one sample carrier when the at least one sample carrier is mounted at one of the plurality of sample carrier positions.

In some embodiments, the autosampler includes a positioning system, and the scanning unit is provided by the positioning system, and the positioning system comprises a rail, with the RFID reader mounted on the rail.

In some embodiments, the positioning system comprises an X-axis actuator configured to move the RFID reader along the rail such that the at least one RFID reader moves along the X-axis.

In some embodiments, the sampling system is mounted on the positioning system.

In some embodiments, the sampling system comprises a first arm mounted on the rail such that the X-axis actuator is configured to move the first arm along the X-axis, and a second arm mounted on the first arm with a carriage having a sampling probe thereon mounted on the second arm. The second arm is configured to be moved along a Y-axis by a Y-axis actuator to thereby control the sampling probe to collect a sample from one of the plurality of sample containers.

In some embodiments, the autosampler includes a Z-axis actuator configured to move the carriage and sampling probe along the Z-axis along the second arm.

In some embodiments, the at least one sample carrier comprises a plurality of sample carriers and the at least one RFID tag comprises a corresponding plurality of RFID tags. Each of the plurality of sample carriers has a corresponding one of the plurality of RFID tags mounted thereon. The RFID reader mounted on the scanning unit is configured to receive a signal from each of the plurality of RFID tags when then corresponding one of the plurality of sample carriers is mounted in one of the at least one positions on the platform.

In some embodiments, the signal from the RFID tag on the sample carrier includes information defining a location and/or presence of the sample carrier on the platform.

In some embodiments, the signal from the RFID tag includes a configuration of the sample carrier, the configuration including a number of sample containers in the sample carrier, an arrangement of sample containers in the sample carrier, and/or a size of the sample carrier.

In some embodiments, the RFID reader is in communication with a carrier identifier. The carrier identifier is configured to receive a position of the RFID reader from the positioning system to determine a corresponding one of the plurality of carrier positions when the signal is received from the RFID tag.

According to some embodiments, a method for sampling includes providing a platform that defines two or more sample carrier positions; mounting at least one sample carrier on the platform in one of the two or more sample carrier positions, the at least one carrier being configured to receive a plurality of sample containers and having an RFID tag thereon; moving an RFID reader between at least two of the two or more sample carrier positions; receiving a signal from the RFID tag on the sample carrier using the RFID reader; determining a configuration and/or position of the sample carrier responsive to the signal from the RFID tag; and withdrawing a sample from at least one of the sample containers with a sample system based on the configuration and/or position of the sample carrier.

In some embodiments, the method includes moving the RFID reader along an X-axis with a scanning unit to the plurality of sample carrier positions such that the RFID reader is configured to receive a signal from the at least one RFID tag on the at least one sample carrier when the at least one sample carrier is mounted at one of the plurality of sample carrier positions.

In some embodiments, the scanning unit is provided by a positioning system, and the positioning system comprises a rail, with the RFID reader mounted on the rail.

In some embodiments, the positioning system comprises an X-axis actuator, and moving the at least one RFID reader includes moving the RFID reader along the rail such that the RFID reader moves along the X-axis.

In some embodiments, the sampling system includes a first arm mounted on the rail, and a second arm mounted on the first arm with a carriage having a sampling probe thereon mounted on the second arm. The method can include moving the first arm along the X-axis and moving the second arm along an Y-axis thereby control the sampling probe to collect a sample from one of the plurality of sample containers.

In some embodiments, the sampling system includes a Z-axis actuator. The method can include moving the carriage and sampling probe along the Z-axis along the second arm to thereby control the sampling probe to collect a sample from one of the plurality of sample containers.

In some embodiments, the at least one sample carrier comprises a plurality of sample carriers and the at least one RFID tag comprises a corresponding plurality of RFID tags, each of the plurality of sample carriers having a corresponding one of the plurality of RFID tags mounted thereon. The method can include receiving a signal from each of the plurality of RFID tags by moving the RFID reader when a corresponding one of the plurality of sample carriers is mounted in one of the at least one positions on the platform.

In some embodiments, the RFID reader is in communication with a carrier identifier, and the method can include receiving a position of the RFID reader at the carrier identifier from the positioning system to determine a corresponding one of the plurality of carrier positions when the signal is received from the RFID tag.

### BRIEF DESCRIPTION OF THE DRAWINGS

FIG. 1 is a perspective view of a sample analyzer system according to some embodiments.

FIG. 2 is a fragmentary, front view of the sample analyzer system of FIG. 1.

FIG. 3 is a schematic diagram representing the sample analyzer system of FIG. 1.

FIG. 4 is a perspective view of a sample container forming a part of the sample analyzer system of FIG. 1.

FIG. 5 is a top view of a carrier holding a set of the sample containers of FIG. 4 and forming a part of the sample analyzer system of FIG. 1.

FIG. 6 is a top perspective of the carrier of FIG. 5 holding one sample container.

FIG. 7 is a fragmentary, side view of the sample analyzer system of FIG. 1.

FIG. 8 is a fragmentary, top view of the sample analyzer system of FIG. 1.

FIG. 9 is a schematic diagram representing a controller forming a part of the sample analyzer system of FIG. 1.

FIG. 10 is a flowchart representing methods using the sample analyzer system of FIG. 1.

FIG. 11 represents an image acquired by an optical reader forming a part of the sample analyzer system of FIG. 1.

FIG. 12 represents a second image acquired by the optical reader forming a part of the sample analyzer system of FIG. 1.

FIG. 13 is a fragmentary, top view of a sample analyzer system according to further embodiments.

FIG. 14 is a fragmentary, side view of the sample analyzer system of FIG. 13.

FIG. 15 is a side view of a sample analyzer system according to further embodiments.

FIG. 16 is a perspective view of a sample analyzer system with RFID tags according to some embodiments.

FIG. 17 is a perspective view of a sample analyzer system with RFID tags according to some embodiments.

FIG. 18 is a top view of a carrier holding a set of the sample containers and forming a part of the sample analyzer system of FIG. 16.

FIG. 19 is a top perspective of the carrier of FIG. 18 holding one sample container and having an RFID tag thereon.

FIG. 20 is a schematic diagram representing the sample analyzer system of FIG. 16.

FIG. 21 is a schematic diagram representing a controller forming a part of the sample analyzer system of FIG. 16.

### DETAILED DESCRIPTION

The present technology now will be described more fully hereinafter with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, operations, elements, and/or components, but do not preclude the presence or addition of one or more other features, integers, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

The term “automatically” means that the operation is substantially, and may be entirely, carried out without human or manual input, and can be programmatically directed or carried out.

The term “programmatically” refers to operations directed and/or primarily carried out electronically by computer program modules, code and/or instructions.

The term “electronically” includes both wireless and wired connections between components.

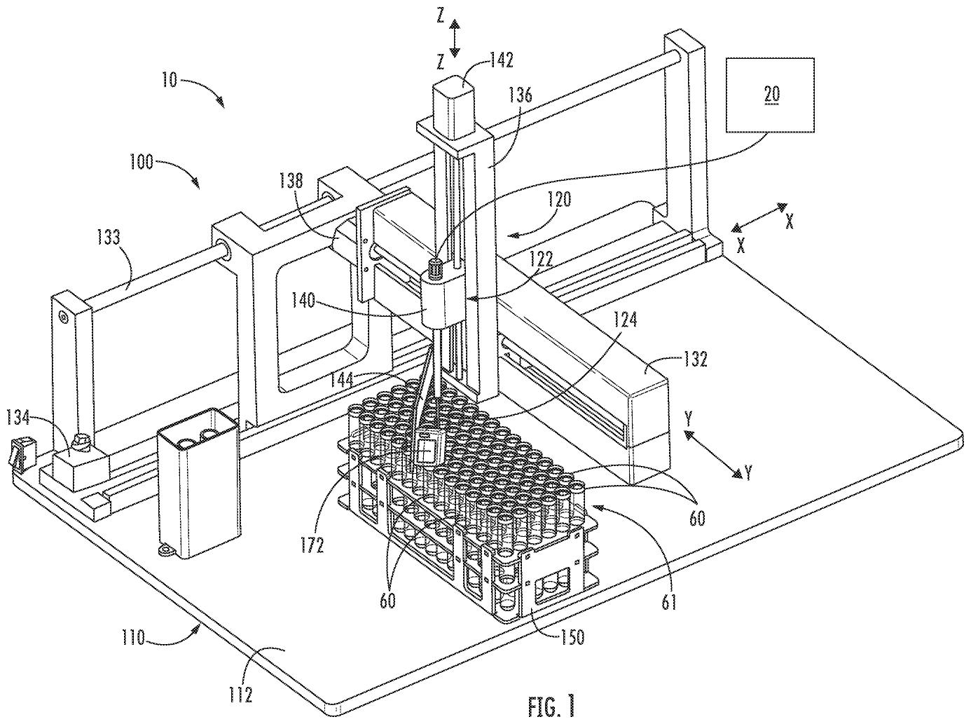

With reference to FIGS. 1-9, a sample analyzer system 10 according to some embodiments of the technology is shown therein. The sample analyzer system 10 includes an automated sampler device or autosampler 100, an analytical instrument 20, a controller 50, and a plurality of sample containers 60. The system 10 may include a human-machine interface (HMI) 12 such as a display with a touchscreen. According to embodiments of the technology, the autosampler 100 is configured and used to supply samples from the sample containers 60 to the analytical instrument 20. For example, in some embodiments, the autosampler 100 automatically and programmatically supplies samples from the sample containers 60 to the analytical instrument 20, and the analytical instrument 20 serially processes the supplied samples.

The analytical instrument 20 may be any suitable apparatus for processing a sample or samples. The analytical instrument 20 may include one or more systems for analyzing a sample in a container such as a tube, including but not limited to an atomic absorber, an inductively coupled plasma (ICP) instrument, a gas chromatography system, a liquid chromatography system, a mass spectrometer, a thermal measurement instrument such as a calorimeter or thermogravimetric analyzer, a food (e.g., grain, dough, flour, meat, milk, etc.) analyzer, or combinations of any of the foregoing, for example.

The autosampler 100 includes a support frame 110, an extraction or sampling system 120, a positioning system 130, a sample container monitoring system 170, one or more carriers 150, and a plurality of the sample containers 60.

The frame 110 includes a deck or platform 112. In use, the carrier 150 is mounted on the platform 112. In some embodiments, the carrier 150 may be a discrete component that is conveniently removable from the platform 112. In other embodiments, the carrier 150 is integrally formed with or substantially permanently affixed to the frame 110. A plurality of sample carriers 150 each loaded with sample containers 60 may be mounted on the platform 112 and accessed by the autosampler 100 as described herein.

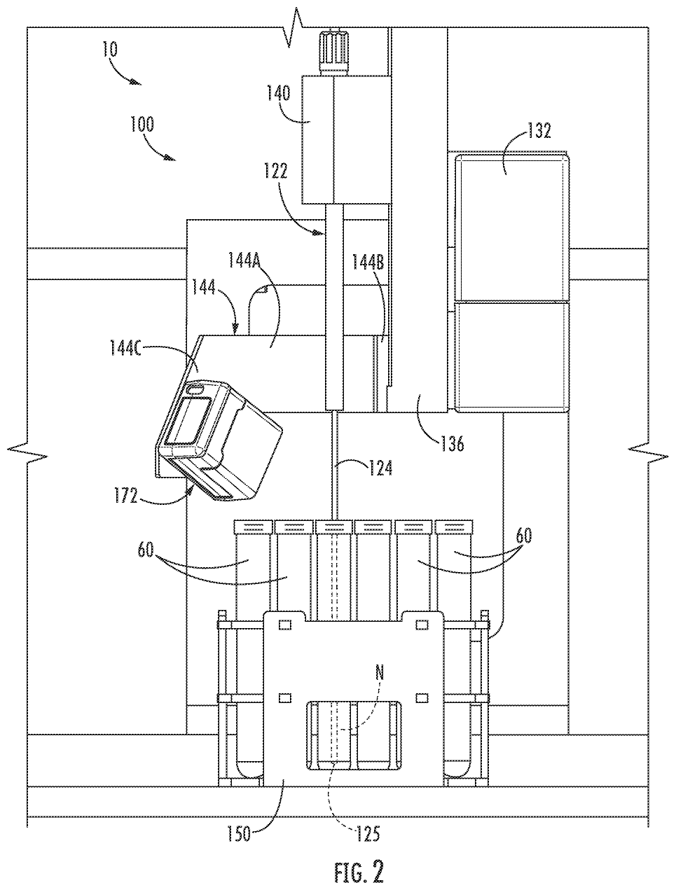

The sampling system 120 includes a sampling head 122. The sampling head 122 includes a probe 124 having a lower tip 125 (FIG. 2). The sampling head 122 may be a syringe and the probe 124 may be a needle, for example.

The positioning system 130 includes a support rail 133, a first arm 132, an X-axis actuator 134, a second arm 136, a Y-axis actuator 138, a shuttle or carriage 140, a Z-axis actuator 142, and a reader mount structure 144.

The first arm 132 is mounted on the rail 133. The first arm 132 can be selectively translated relative to the rail 133 (and the platform 112) in opposed directions (e.g., left and right) along a first axis X-X by the X-axis actuator 134.

The second arm 136 is mounted on the first arm 132. The second arm 136 can be selectively translated relative to the first arm 132 (and the platform 112) in opposed directions (e.g., in and out) along a second axis Y-Y by the Y-axis actuator 138. The Y-axis actuator 138 may be a linear actuator.

The carriage 140 is mounted on the second arm 136. The carriage 140 can be selectively translated relative to the second arm 136 (and the platform 112) in opposed directions (e.g., up and down) along a third axis Z-Z by the Z-axis actuator 142.

The sampling head 122 is mounted on the carriage 140 for movement therewith. It will be appreciated that the sampling head 122 (and the tip 125 of the probe 124) can be selectively positioned and repositioned in three dimensional space (along the X-, Y- and Z- axes) as desired using the actuators 134, 138, 142.

The reader mount structure 144 is mounted on (e.g., affixed to or integrally formed with) the second arm 136 for movement therewith. With reference to FIG. 2, the reader mount structure 144 includes an arm 144A secured at a proximal end 144B to the second arm 136 (FIG. 1) and extending (e.g., cantilevered) to a distal end 144C. A barcode reader 172 (discussed below) is mounted on the distal end 144C. The barcode reader 172 is thereby laterally spaced apart from the probe 124.

It will be appreciated that the barcode reader 172 can be selectively positioned and repositioned in two dimensional space (along the X- and Y-axes) as desired using the actuators 134, 138. It will be appreciated that the barcode reader 172 will move in tandem with the sampling head 122 except in the case of movement of the sampling head 122 along the Z-axis with the carriage 140.

The controller 50 may be any suitable device or devices for providing the functionality described herein. The controller 50 may include a plurality of discrete controllers that cooperate and/or independently execute the functions described herein. The controller 50 may include a microprocessor-based device including, for example, a computer, tablet or smartphone.

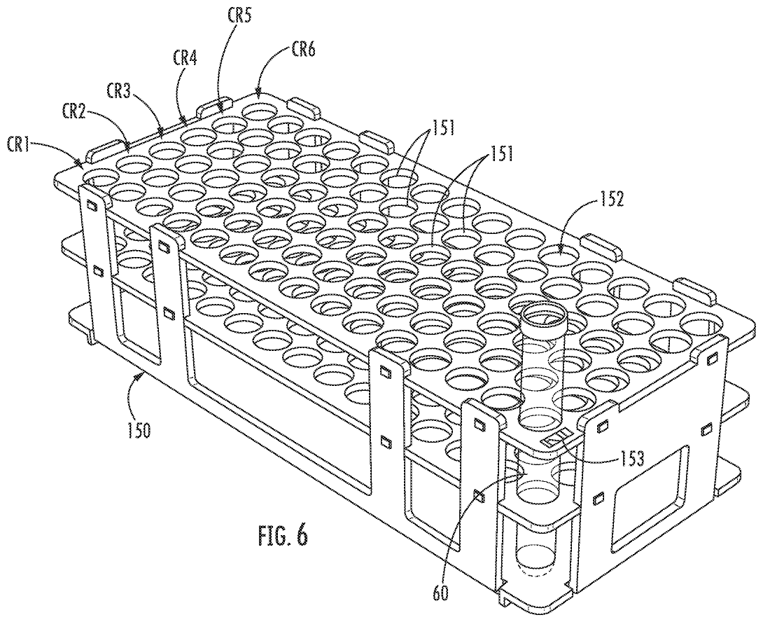

The carrier 150 may be a platter, tray, rack or the like. The carrier 150 may be configured to be stably mounted on the platform 112, for example. In some embodiments, a plurality of sample container seats 151 (FIG. 6) are provided in the carrier 150. Each seat 151 includes one or more openings defining a bore, receptacle or slot 152 sized to receive (from above), positively position, and releasably hold a respective sample container 60.

The seats 151 may be arranged in a prescribed configuration so that each seat has a prescribed location in the carrier, and a sample container mounted in the seat has a corresponding prescribed location in the carrier 150. In some embodiments, the seats 151 are arranged in an array. In some embodiments, the seats 151 are arranged in a two-dimensional array having substantially linear or rectilinear rows of seats 151.

In some embodiments and as shown in FIG. 6, the seats 151 are arranged in the carrier in an array including a plurality of side-by-side, linear rows CR1-CR6. Each row CR1-CR6 has a central axis. In some embodiments and as shown, the central axes of the rows CR1-CR6 are substantially parallel. In some embodiments, the rows CR1-CR6 are substantially straight with each seat being substantially centered on its row's central axis.

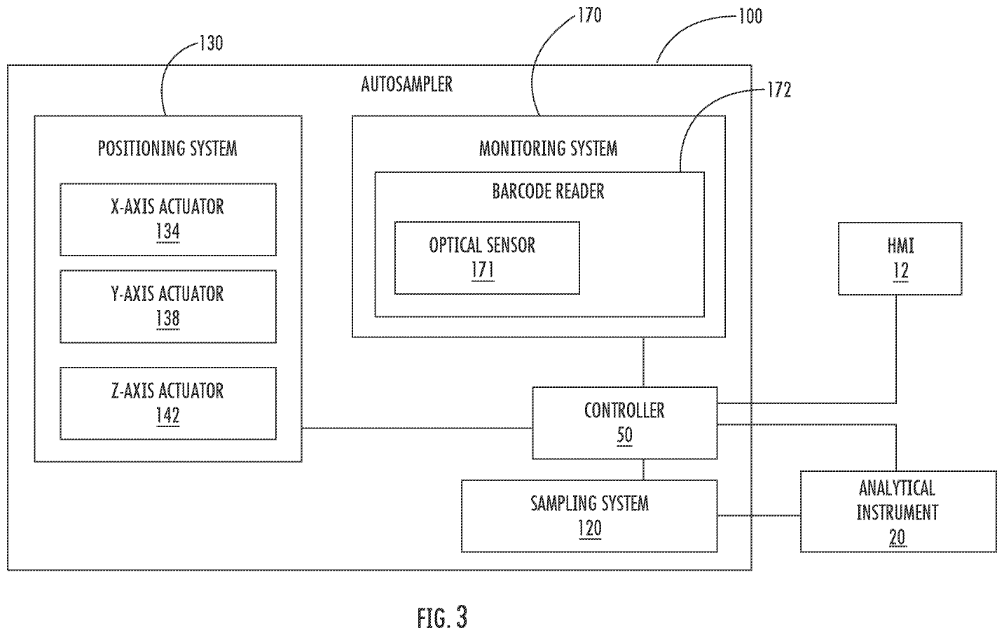

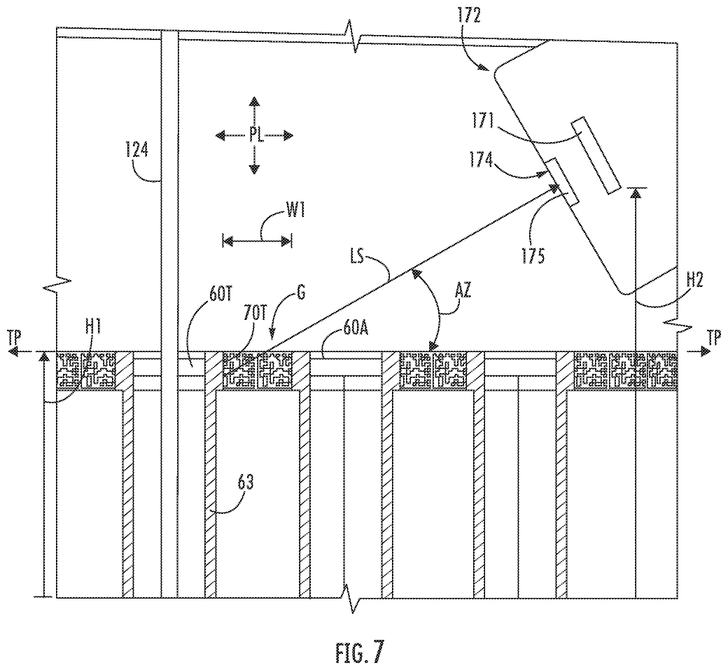

As depicted in the illustrated embodiment of FIG. 3, the sample container monitoring system 170 includes an optical sensor 171. According to some embodiments such as that shown in FIG. 7, the optical sensor 171 forms a part of an optical reader 172. In some embodiments, the optical reader is a barcode reader 172. The illustrated barcode reader 172 has an optical reception window 174 (FIG. 7). The barcode reader 172 may include a lens 175 that provides the optical sensor 171 with an extended or wide angle field of view. The sample container monitoring system 170 may include a supplemental light source apart from or integrated into the barcode reader 172.

Suitable barcode readers for the optical sensor 171 and barcode reader 172 may include a camera or laser scanner barcode reader.

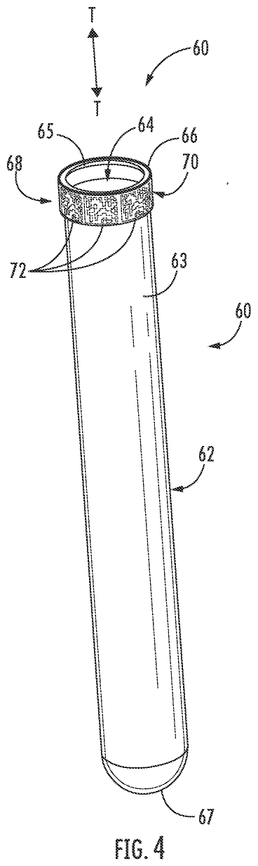

An exemplary one of the sample containers 60 is shown in FIG. 4. The sample container 60 has a top end 66 and an opposed bottom end 67. The sample container 60 has a container axis T-T extending between the top end 66 and the bottom end 67.

The sample container 60 includes a vessel 62. In some embodiments, the vessel 62 is a cylindrical vial as shown. The vessel 62 includes a sidewall 63 and defines a containment chamber 64 terminating at an inlet opening 65 at or proximate the top end 66. The vessel 62 may be formed of any suitable material(s). In some embodiments, the vessel 62 is formed of a material selected from the group consisting of polymer, metal or glass.

The sample container 60 may further include an inlet end cap (not shown) fluidly sealing the opening and having a penetrable septum. The septum may be formed of any suitable material(s). In some embodiments, the septum is formed of a rubber.

The sample container 60 has an indicia region 68 on the sidewall 63 proximate the top end 66. The sample container 60 further includes visible indicium 70 on the sidewall 63 in the indicia region 68.

The visible indicium 70 may be any suitable computer readable indicium. The visible indicium 70 may be any suitable coded, symbolic or identifying indicium. In some embodiments, the visible indicium 70 is a two-dimensional barcode. In some embodiments and as shown in the figures, the visible indicium 70 is a two-dimensional data matrix barcode distributed across the height and circumference of the sample container 60. The indicium 70 may include one or more forms of indicia.

In some embodiments and as shown in the figures, the visible indicium 70 includes an indicium pattern 72 that is repeated about the circumference of the sample container 60 so that the substantially the entire indicium pattern or a sufficient portion thereof will be visible from every side of the sample container 60.

The barcode (or other visible indicium) 70 may be formed of any suitable material(s) and may be secured to the vessel 62 by any suitable technique. In some embodiments, the barcode 70 is permanently located (i.e., secured or formed) on the vessel 62. In some embodiments, the barcode 70 is permanently embossed or etched into a surface (e.g., the outer surface) of the vessel 62. In some embodiments, the barcode 70 is printed (and, in some embodiments, permanently printed) on a surface (e.g., the outer surface) of the vessel 62. In some embodiments, the barcode 70 is located (e.g., printed) on a separate label component (e.g., a self-adhesive backed label) that is adhered onto a surface (e.g., the outer surface) of the vessel 62.

The sample analyzer system 10 can be used and operated as follows in accordance with methods of the present technology. The controller 50, the actuators 134, 138, 142, the barcode reader 172, the sampling system 120, and the analytical instrument 20 collectively serve as a control system operative to execute the methods.

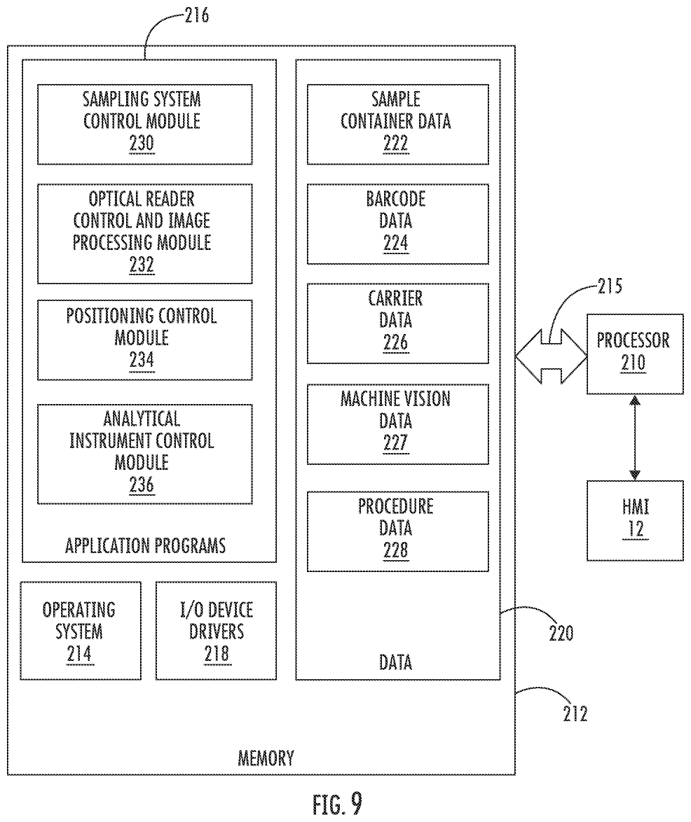

A set 61 (FIG. 1) of the sample containers 60 is mounted in the carrier 150. The sample containers 60 of the set 61 are each mounted in a respective one of the slots 152 of the seats 151 in the carrier 150. Each sample container 60 and its position in the carrier 150 may be identified and registered or indexed in a sample container data memory 222 (FIG. 9) associated with the controller 50. Each sample container 60 has a unique identity that is represented in its barcode 70. The carrier 150 may also be identified and its seats 151 individually registered or indexed in a carrier data memory 226.

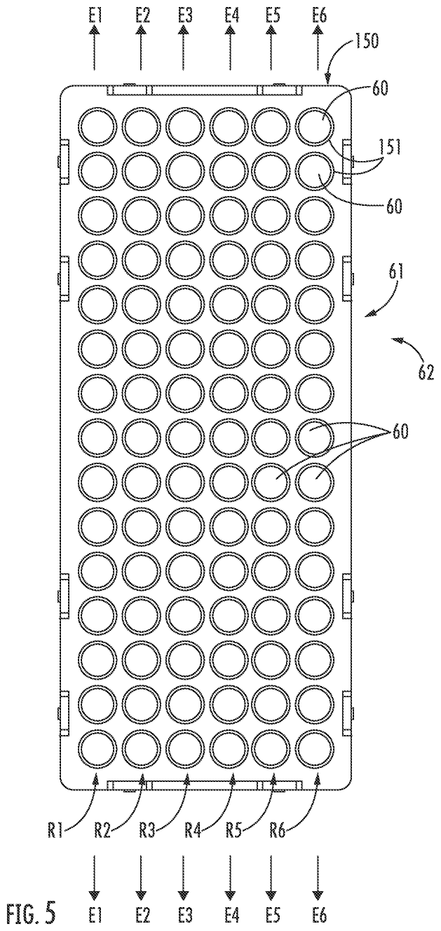

The sample containers 60 are arranged in the carrier 150 in an array 62 including a plurality of side-by-side rows R1-R6 corresponding to carrier seat rows CR1-CR6 (FIGS. 5 and 6), respectively. Each row R1-R6 has a central row axis E1-E6. In some embodiments and as shown in FIG. 5, the central axes E1-E6 are substantially parallel. In some embodiments, the rows R1-R6 are substantially linear, rectilinear or straight with each sample container 60 being substantially centered on its row's central axis E1-E6.

The top ends 66 of the sample containers 60 in the carrier 150 define a top plane TP-TP (FIG. 7). In some embodiments, the top plane TP-TP is a horizontal plane located at the height H1 of the highest sample container top end 66 of the array 62 in the carrier 150. In some embodiments, the heights of the top ends 66 of the sample containers 60 in the array 62 are all within about 1 mm of one another and, in some embodiments are all within about 0.5 mm of one another.

The carrier 150 with the sample container set 61 mounted therein is mounted on the platform 112.

Generally, when it is desired to analyze the sample N (FIG. 2) in a selected one of the sample containers 60 (referred to herein as the “target sample container”), the controller 50 operates the actuator 134 to reposition the arm 132 along the X-axis, and operates the actuator 138 to reposition the arm 136 along the Y-axis such that the probe tip 125 is positioned directly over the target sample container 60. The controller 50 then operates the actuator 142 to lower the carriage 140 along the Z-axis. The probe tip 125 is thereby lowered into the target sample container 60. The controller 50 then operates the sampling system 120 to withdraw a sample N from the chamber 64 of the target container 60 and transfer the sample to the analytical instrument 20.

The controller 50 then operates the actuator 142 to raise the carriage 140 along the Z-axis and thereby remove the probe 124 from the target sample container 60. The controller 50 can thereafter repeat the foregoing procedure to withdraw samples from other selected sample containers 60 in the carrier 150.

In use, it may be necessary or desirable to scan or read the indicium 70 of the target sample container 60 and/or determine whether a sample container 60 is present at the target location (i.e., the corresponding seat 151). For this purpose, the barcode reader 172 is selectively repositioned along with the probe 124 to a reading position with respect to the target sample container 60.

Because the barcode reader 172 is mounted on the structure 144, the barcode reader 172 will travel with the second arm 136 along the X- and Y-axes, but will not move up and down with the carriage 140. As a result, the X-Y position of the barcode reader 172 with respect to the probe 124 is fixed, but the probe 124 can be repositioned along the Z-axis with respect to the barcode reader 172. The barcode reader 172 can be repositioned on the X- and Y-axes with respect to the sample container set 61 as described for the probe 124, but will maintain a position above the sample containers 60.

Accordingly, in some embodiments and as shown, the barcode reader 172 will be in its reading position with respect to a target sample container 60 when the probe 124 is aligned with the target sample container 60 on the X- and Y-axes. However, in other embodiments the autosampler may be constructed and operated such that the barcode reader 172 and the probe 124 are moved independently of one another in the X-axis and/or Y-axis, and/or such that the barcode reader 172 is moved with the probe 124 along the Z-axis.

When the barcode reader 172 is in the reading position with respect to a target sample container 60, the barcode 70 of the target sample container 60 is in the field of view of the barcode reader 172, as described in more detail below. The barcode reader 172 will scan or read the barcode 70 and send an output signal corresponding to the barcode 70 to the controller 50. More particularly, in some embodiments, the barcode reader 172 (including the optical sensor 171) is configured to generate an electrical output signal having voltage levels in a pattern corresponding to the barcode 70 (visible indicium). The controller 50 is configured to receive and process the output signal. In some embodiments, the output signal represents or embodies image data corresponding to the barcode 70 of the target sample container 60. The output signal will be described hereinbelow with reference to image data; however, in some embodiments, the output signal may represent or embody data other than image data, such as a one dimensional data string.

The controller 50 will process the image data to determine the location of the barcode 70 of the target sample container 60 with respect to the carrier seats 151 and to decrypt the data embodied in the barcode 70. In some embodiments, the controller 50 programmatically and automatically processes the image data to determine said location and decrypt said data.

The controller 50 will then execute an appropriate action depending on the acquired data. For example, if the barcode 70 of the target sample container 60 confirms the target sample container 60 is correct for sampling (e.g., properly identified and in the correct location), the controller 50 will then operate the actuator 142 to lower the probe tip 125 into the target sample container to extract and transfer an aliquot of the sample N in the sample container 60 to the analytical instrument 20 as described above.

If the controller 50 determines from the data acquired from the barcode reader 172 that a fault is present, the controller 50 will execute an alternative action. Such faults may include: a sample container 60 is not present in the target seat 151; a sample container 60 is present in the target seat 151 but the barcode 70 data is indeterminate; or the sample container 60 present in the target seat 151 is not the correct sample container 60. Alternative action may include halting the autosampling procedure, skipping the target sample container or seat and continuing to the next target sample container or seat, and/or issuing or logging a fault alert or report.

When in its reading position with respect to a given sample container 60, the barcode reader 172 is positioned above the plane TP-TP (FIG. 7) of the top ends 66 of the sample containers 60, and the line of sight LS of the barcode reader 172 intersects the barcode of the sample container. The line of sight LS extends downward from a height above the height of the top plane TP-TP of the sample containers 60, at an oblique angle to the top plane TP-TP, and through a gap defined between the target sample container and another one of the sample containers in the carrier 150.

For example, FIG. 7 shows the barcode reader 172 in a reading position relative to a target sample container 60T having a target barcode 70T. As shown, the lens 175 of the barcode reader 172 is located above and laterally offset from the target sample container 60T. The probe 124 is located directly above or in the target sample container 60T. The line of sight LS of the barcode reader 172 intersects the target barcode 70T, thereby enabling the barcode reader 172 to read the target barcode (or other indicium) 70T. The line of sight LS of the barcode reader 172 extends downward from a height H2 above the height H1 of the top plane TP-TP.

The line of sight LS extends at an oblique vertical offset angle AZ to the top plane TP-TP. More particularly, the line of sight LS lies entirely in a line of sight plane PL-PL that is orthogonal to the top plane TP-TP (FIG. 7; as shown, parallel to the Z-axis). The oblique vertical offset angle AZ is defined in the line of sight plane PL-PL between the line of sight LS and the top plane TP-TP.

According to some embodiments, the vertical offset angle AZ (FIG. 7) is at least 30 degrees. According to some embodiments, the vertical offset angle AZ is in the range of from about 30 to 60 degrees and, in some embodiments, is in the range of from about 45 to 90 degrees.

The line of sight LS extends through a void or gap G defined between the target barcode 70T and an adjacent, intervening sample container 60A of the array 62 in the carrier 150. The intervening sample container 60A is located laterally between the barcode reader 172 and the target barcode 70T, but is located below the line of sight LS so that the view of the barcode reader 172 to the target barcode 70T is not blocked by the intervening sample container 60A.

According to some embodiments, the gap G has a width W1 from the target sample container 60T to the intervening sample container 60A of at least about 1 mm. According to some embodiments, the width W1 is in the range of from about 1 mm to 6 mm.

Incident light rays emanating from the target barcode 70T (e.g., ambient light reflected from the visible indicium 70T) travel generally along the line of sight LS to the reception window 174. In some embodiments, the light rays travel substantially parallel to the reception axis of the barcode reader 172. The image is detected by the optical sensor 171 and processed by the barcode reader 172 as described above.

In some embodiments, the barcode reader 172 has a prescribed depth of field extending from a minimum view distance to a maximum view distance, and a focal length that is between the minimum and maximum view distances. In some embodiments, the positioning system 130 positions the barcode reader 172 such that the target barcode 70T is in the prescribed depth of field of the barcode reader 172. For example, the fixed lateral distance between the probe 124 and the barcode reader 172 and the height of the barcode reader 172 over the carrier 150 can be set or selected to provide the desired distance when the probe 124 is vertically aligned with the target sample container 60T.

The controller 50 decrypts the target barcode 70T so that the data contained therein is associated with the target sample container 60T and can thereafter be associated with the sample container and the sample throughout the procedure.

According to some embodiments, when the barcode reader 172 is in its reading position with respect to a given sample container 60, the line of sight LS (which intersects the barcode 70T of the target sample container 60T) also extends at an oblique lateral offset angle to the row axis of the sample container row including the target sample container in the carrier 150.

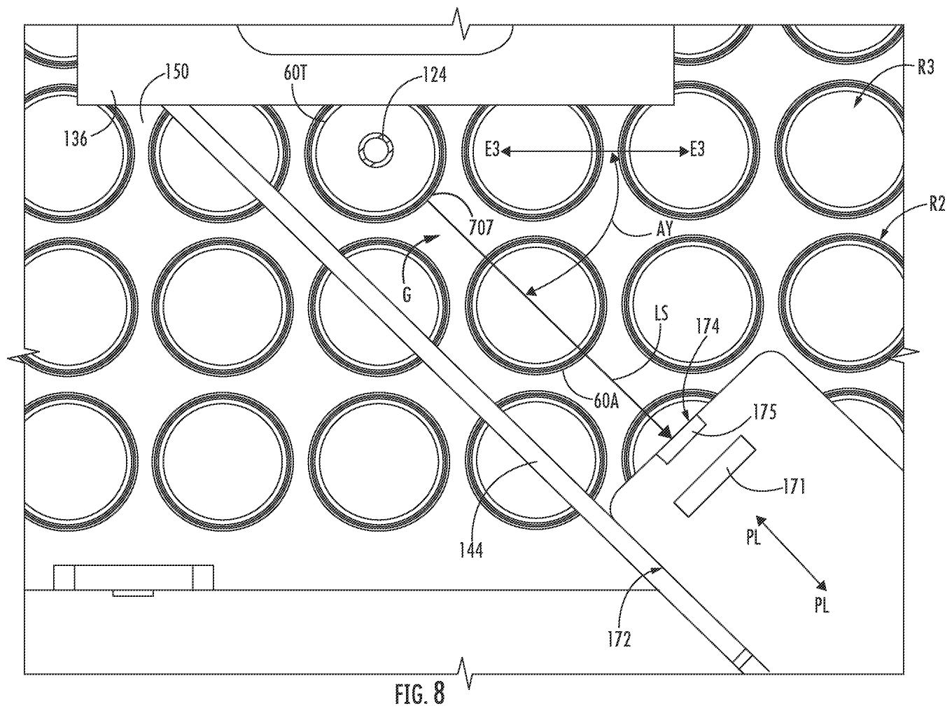

For example, as shown in FIG. 8, the target sample container 60T is located in the row R3 having a row axis E3-E3. The oblique lateral offset angle AY is the angle defined between the row axis E3-E3 and the line of sight plane PL-PL (FIG. 8; i.e., the angle at which the row axis R3 intersects the line of sight plane PL-PL).

According to some embodiments, the lateral offset angle AY (FIG. 8) is at least 30 degrees and, in some embodiments, at least 45 degrees. According to some embodiments, the lateral offset angle AY is in the range of from about 30 to 90 degrees and, in some embodiments, is in the range of from about 30 to 60 degrees.

According to some embodiments, when the barcode reader 172 is in its reading position with respect to a given sample container 60, the line of sight LS (which intersects the barcode 70T of the target sample container 60T) extends through a gap between the selected sample container and an adjacent sample container in the carrier 150 located in a row adjacent the row that includes the selected sample container. For example, as shown in FIG. 8 the target sample container 60T is included in the row R3. The adjacent sample container 60A is located in the adjacent row R2. The line of sight LS extends through the void or gap G defined between the target sample container 60T and the adjacent sample container 60A.

The foregoing arrangement may be particularly advantageous when the line of sight LS extends at an oblique lateral offset angle (e.g., angle AY) to the row axis (e.g., row axis E3-E3), the sample containers 60 are arranged in linear lengthwise rows and linear widthwise rows (e.g., as shown in FIG. 5), and the sample containers 60 are cylindrical. In this case, the sample containers 60 may be closely packed with little or no spacing between adjacent sample containers along the lengthwise and widthwise row axes. However, as can be seen in FIG. 8, relatively large gaps G are present on a diagonal between diagonally adjacent sample containers 60.

In some embodiments, the barcode reader 172 is also used to identify the carrier 150 or the type/layout of the carrier. In some embodiments, this is accomplished by providing a barcode 153 (FIG. 6) (or other suitable indicium) on the carrier 150. The barcode reader 172 will read the barcode 153 and send an output signal corresponding to the barcode 153 to the controller 50 (e.g., as discussed above for the barcode 70). The controller 50 will receive and process the output signal (e.g., the image data) to determine the specific identity or type of the carrier. From this, the controller 50 can determine the layout of the carrier (e.g., sizes, shapes and/or relative positions of the seats 151). In some embodiments, the controller 50 programmatically and automatically processes the image data to determine said identity or type.

The controller 50 may then execute an appropriate action depending on the acquired data. For example, the identification of the type of carrier can be used to validate that the operator correctly entered the configuration of the carrier 150 in the procedure set up (e.g., through the HMI 12).

In some embodiments, the barcode reader 172 is also used to identify the carrier 150 or the type/layout of the carrier and/or to identify missing sample containers using machine vision. The barcode reader 172 will scan the carrier 150 and send an output signal corresponding to, e.g., an acquired image, to the controller 50. The controller 50 will receive and process the image data from the output signal. In some embodiments, the controller 50 will use the image data to determine the type of the carrier. From this, the controller 50 can determine the layout of the carrier (e.g., sizes, shapes and/or relative positions of the seats 151), the sizes of the seats 151 (e.g., the openings of the seats 151), and/or the presence and sizes of sample containers 60 in the carrier 150. In some embodiments, the controller 50 will use the image data to determine whether any seat 151 that is registered as holding a sample container is actually empty of any sample container (i.e., a missing sample container).

The controller 50 may then execute an appropriate action depending on the acquired data. For example, the identification of the type of carrier can be used to validate that the operator correctly entered the configuration of the carrier 150 in the procedure set up (e.g., through the HMI 12). If the controller 50 determines (from the data acquired from the barcode reader 172) that there is a difference between the outer diameter of a sample container 60 in the carrier 150 and the sample container outer diameter appropriate for the carrier configuration entered by the operator (e.g., a mis-sized sample container has been mounted in the carrier 150), the controller may issue an alert to the user and report the error prior to beginning or continuing a run. If the controller 50 determines (from the data acquired from the barcode reader 172) that that no sample container 60 is present in the carrier 150 at a location (e.g., seat) where a sample container should be present based on the information entered by the operator (i.e., there is an unintended empty seat 151), the controller may issue an alert to the user and report the error prior to beginning or continuing a run. In some embodiments, the controller 50 programmatically and automatically processes the acquired bar code (e.g., image) data as discussed herein. In some embodiments, the controller 50 programmatically and automatically processes the image data to identify a missing sample container as discussed herein before attempting to withdraw a sample from the target location in the carrier.

As discussed herein, traceability of samples is extremely important in analytical laboratories. The barcodes 70 give the sample containers 60 (and the samples contained therein) a unique identification that may be logged into a database for tracking. High throughput labs run many samples per day through analytical instruments. These labs often use autosamplers that stack many samples in an array. Reading barcodes on sample containers in a densely packed two-dimensional array is typically challenging because there is little spacing between sample containers, preventing reading of the barcodes. In some known apparatus, each selected sample container is removed from the carrier and moved to a position where a barcode reader can achieve a line of sight to conduct a reliable reading of the barcode. This process increases the cost of the autosampler and can contribute to sample contamination because the sample containers must be touched.

In contrast, the disclosed configuration of the autosampler 100 and the monitoring system 170 enable the barcode reader 172 to read the barcode 70 of each target sample container 60 even though the target sample container may be located within a dense array of the sample containers. Even though the barcode of a target sample container may be obfuscated by one or more other sample containers in the carrier 150 when viewed from a directly lateral direction (i.e., horizontally) and is not visible from directly above (because the barcode is on the vessel sidewall), the disclosed arrangement of the autosampler exposes the barcode indicium to the barcode reader.

As a result, the barcode 70 of each sample container 60 can be scanned by the barcode reader 172 without removing the sample container 60 from its seat 151 or rotating the sample container 60. The autosampler 100 does not require that the sample containers be touched or moved, thus saving time, increasing efficiency, and significantly reducing if not entirely eliminating the risk of sample cross-contamination.

In some embodiments, the probe 124 is disposed in the target sample container 60 when the barcode reader is in its reading position with respect to the target sample container. In some embodiments, the probe 124 is disposed above, but not in, the target sample container 60 when the barcode reader is in its reading position with respect to the target sample container.

In some embodiments, the carrier does not have prescribed, individually partitioned slots to receive each sample container. Instead, the carrier may include prescribed locations that the sample containers assume when the carrier is filled.

The optical sensor 171 (e.g., barcode reader 172) and the carrier 150 may be moved relative to one another in ways other than those described above to selectively position the optical sensor in the reading location with respect to each target sample container. For example, the autosampler may be configured to move the carrier relative to the barcode reader, to move the barcode reader relative to the carrier (e.g., as described for the autosampler 100), or a combination of the two.

In some embodiments, the optical sensor 171 (e.g., barcode reader 172) may be moved independently of the probe 124 or other apparatus for extracting a sample from the sample containers.

The sampling system of the inventive autosampler may be configured to extract or withdraw samples from the sample containers 60 in any suitable manner. In some embodiments, the sampling system withdraws the sample from the sample container while the sample container is disposed in the carrier. In some embodiments, the sampling system (e.g., the sampling system 120) includes a probe 124 that is inserted into the sample container 60 and a negative pressure is induced in the probe to aspirate the sample into the probe. The aspirated sample may then be transferred to an inlet of the analytical instrument from the probe. For example, the aspirated sample may be transferred through a conduit between an outlet of the probe and an inlet of the analytical instrument. Alternatively, the probe may be inserted into an inlet (e.g., an injection port) of the analytical instrument and the sample then dispensed from the probe into the inlet. In further embodiments, the probe (e.g., a pin probe) may be inserted into and removed from the sample container such that a droplet of the sample adheres to the probe, and the probe is then moved to an inlet of the analytical instrument to deposit the droplet.

In some embodiments, the sample container is removed from the carrier and transferred to another location or withdrawal station, where the sampling system then withdraws the sample from the sample container. In this case, the withdrawal station may be a part of the analytical instrument or a supplemental station. For example, in some embodiments, after reading and processing a sample container's barcode 70, the sample container is transferred (e.g., by a robotic end effector) to a withdrawal station where a probe aspirates or otherwise removes a sample from the sample container, and then transfers the sample to the analytical instrument as described herein (e.g., via a conduit or injection port). In some embodiments, the withdrawal station may withdraw the sample from the sample container without a probe (e.g., by flowing a carrier gas through the sample container (e.g., a thermal desorption tube)).

Operations described herein can be executed by or through the controller 50. The actuators 134, 138, 142 and other devices of the system 10 can be electronically controlled. According to some embodiments, the controller 50 programmatically executes some, and in some embodiments all, of the operations or actions described. According to some embodiments, the movements of the actuators are fully automatically and programmatically executed by the controller 50.

In some embodiments, the controller 50 programmatically and automatically executes each of the operations or actions of reading the barcodes 70, processing the (e.g., image) data to determine the locations and data contents of the barcodes 70, 153, machine vision scanning, and processing the (e.g., machine vision image) data to determine the type and contents of the carrier. In some embodiments, the controller 50 programmatically and automatically executes each of the parts or actions of operation of the autosampler device 100 described herein.

Embodiments of the controller 50 logic may take the form of an entirely software embodiment or an embodiment combining software and hardware aspects, all generally referred to herein as a “circuit” or “module.” In some embodiments, the circuits include both software and hardware and the software is configured to work with specific hardware with known physical attributes and/or configurations. Furthermore, controller logic may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or other storage devices.

FIG. 9 is a schematic illustration of a circuit or data processing system 202 that can be used in the controller 50. The circuits and/or data processing systems may be incorporated in a digital signal processor 210 in any suitable device or devices. The processor 210 communicates with the HMI 12 and memory 212 via an address/data bus 215. The processor 210 can be any commercially available or custom microprocessor. The memory 212 is representative of the overall hierarchy of memory devices containing the software and data used to implement the functionality of the data processing system. The memory 212 can include, but is not limited to, the following types of devices: cache, ROM, PROM, EPROM, EEPROM, flash memory, SRAM, and DRAM.

FIG. 9 illustrates that the memory 212 may include several categories of software and data used in the data processing system: the operating system 214; the application programs 216; the input/output (I/O) device drivers 218; and data 220.

The data 220 can include equipment-specific data. FIG. 9 also illustrates that the data 220 can include sample container data 222, barcode data 224, carrier data 226, machine vision data 227, and procedure data 228. The sample container data 222 can include data relating to or representing characteristics of each sample container 60, including a unique identifier (e.g., serial number), name, and description of an analyte contained in the sample container 60, for example. The barcode data 224 can include a registry indexing or cross-referencing barcodes to the serial numbers of the sample containers 60, for example. The carrier data 226 can include seat location data representing spatial or geometric layout or positions of the seats 151 relative to the carrier 150 and the frame 110. The machine vision data 227 can include algorithms, reference images, and other data to assist in interpreting the image data. The procedure data 228 can include data representing a protocol or sequence of actions or operations to execute the procedures described herein (including an analytical sequence, for example).

FIG. 9 also illustrates that application programs 216 can include a sampling system control module 230 (to control the sampling system 120), an optical reader control and image processing module 232 (to control the sample container monitoring system 170 (including the optical sensor 171)), a positioning control module 234 (to control the actuators 134, 138, 142), and an analytical instrument control module 236 to control the analytical instrument 20.

As will be appreciated by those of skill in the art, the operating system 214 may be any operating system suitable for use with a data processing system. The I/O device drivers 218 typically include software routines accessed through the operating system 214 by the application programs 216 to communicate with devices such as I/O data port(s), data storage and certain memory components. The application programs 216 are illustrative of the programs that implement the various features of the data processing system and can include at least one application, which supports operations according to embodiments of the present technology. Finally, the data 220 represents the static and dynamic data used by the application programs 216, the operating system 214, the I/O device drivers 218, and other software programs that may reside in the memory 212.

As will be appreciated by those of skill in the art, other configurations may also be utilized while still benefiting from the teachings of the present technology. For example, one or more of the modules may be incorporated into the operating system, the I/O device drivers or other such logical division of the data processing system. Thus, the present technology should not be construed as limited to the configuration of FIG. 9, which is intended to encompass any configuration capable of carrying out the operations described herein. Further, one or more of the modules can communicate with or be incorporated totally or partially in other components, such as the controller 50.

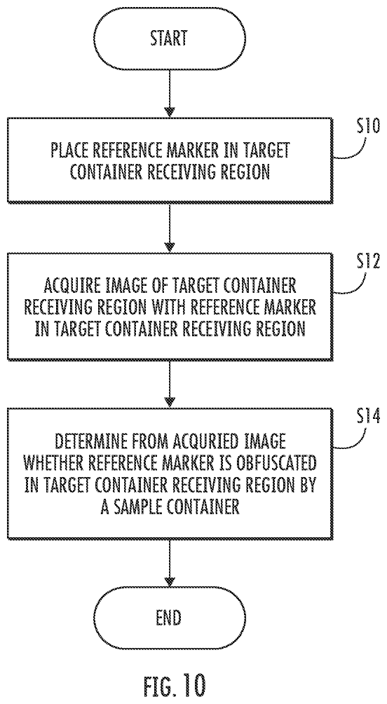

In some embodiments and with reference to FIG. 10, systems and methods as described herein may employ machine vision and a reference marker to determine whether a sample container is present in a target location. A reference marker is placed in a target container receiving region (Block S10). The optical sensor then acquires an image of the target container receiving region with the reference marker disposed in the target container receiving region (Block S12). The controller then determines from the acquired image data whether the reference marker is obfuscated in the acquired image by a sample container disposed in the target container receiving region (Block S14).

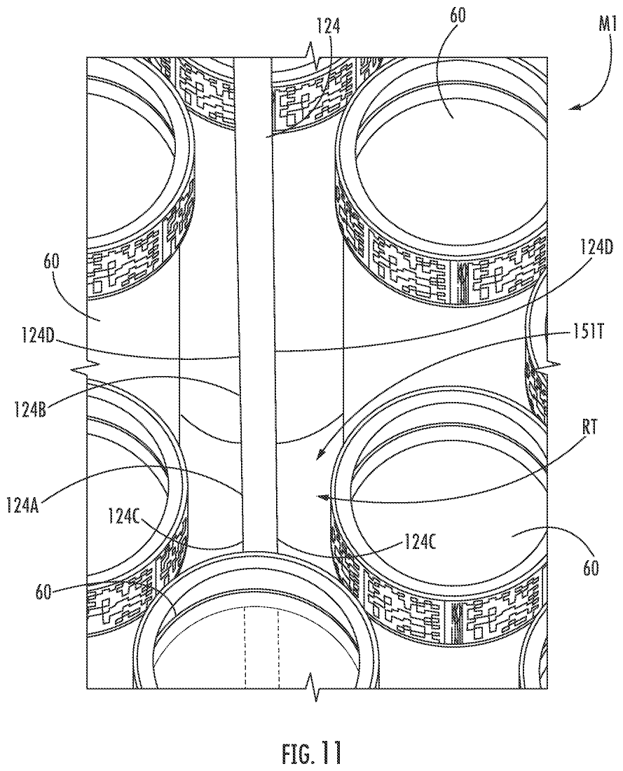

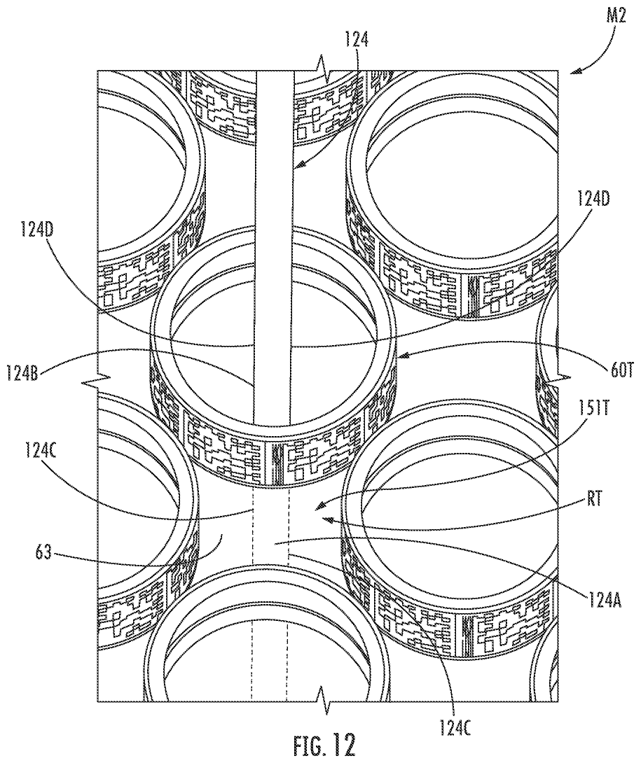

For example, with reference to FIGS. 11 and 12, in some embodiments the system 10 employs machine vision and a reference marker to determine whether a sample container 60 is present in a target location or seat 151T or missing from that location. In some embodiments, the reference marker is the probe 124. The controller 50 positions the probe 124 in the volume RT (the target container receiving region) that would be occupied by a sample container 60 if seated in the target seat 151T. The barcode reader 172 then scans the carrier 150 to thereby acquire an image of the volume, and sends an output signal corresponding to acquired image to the controller 50. The controller 50 receives and processes the image data from the output signal.

FIG. 11 shows an example image M1 of the carrier 150, the sample containers 60, the probe 124, and the target sample container region RT as received at and acquired by the barcode reader 172 and processed by the controller 50, wherein there is no sample container 60 in the region RT. FIG. 12 shows an example image M2 of the same components and region RT in the case where a target sample container 60T is disposed in the target seat 151T.

In particular, the controller 50 evaluates the image of a portion 124A of the probe 124 in a prescribed region to determine whether the portion 124A of the probe is obfuscated by a sample container.

If no sample container 60 is present in the target seat 151T, the controller 50 will identify the probe portion 124A as distinct in the image data. The controller 50 will thereby determine that no sample container is seated in the target seat 151T.

If, alternatively, a sample container 60 is present in the target seat 151T, the probe 124 will have been inserted into the sample container 60. In this case, the image of the probe portion 124A will not be distinct.

If the sample container is sufficiently opaque, the probe portion 124A will be substantially fully obfuscated and undiscernible from the image data. The controller 50 will determine therefrom that a sample container 60 is present in the target seat 151T.

If the sample container is translucent (i.e., only partially transparent so that some light can pass therethrough but detailed images are not visible through the sample container), then the probe portion 124A may be identifiable in the image data. However, the probe portion 124A will appear less distinct (than if the probe portion 124A was not disposed within a sample container). The controller 50 will determine therefrom that a sample container 60 is present in the target seat 151T. The controller 50 may determine that the image of the probe portion 124A is indistinct (and thus indicating the presence of a sample container in the target seat) using any suitable technique(s).

In some embodiments, the controller 50 determines that the edges of the probe portion 124A in the image data are insufficiently sharp and/or the shape of the probe portion image does not correspond to an unobstructed view. For example, the edges 124C of the probe portion 124A in the image M2 or shape of the probe portion 124A in the image M2 may be compared to a reference image in memory or the image of a different portion of the probe (e.g., the edges 124D of a portion 124B of the probe 124 that would be above the top of a sample container, if present, and therefore unobstructed).

In some embodiments, the controller 50 determines that the color and/or darkness of the probe portion 124A in the image data indicate that the barcode reader's view of the probe portion 124A is obstructed. For example, the color or shade of the probe portion 124A may be compared to a reference image in memory or the image of a different portion of the probe (e.g., a portion 124B of the probe that would be above the top of a sample container, if present, and therefore unobstructed). A sufficient color difference or darkness contrast can be used by the controller 50 to register an indistinct probe portion image, and thereby the presence of a sample container.

As discussed herein, if the controller 50 determines in the foregoing manner using a reference marker that no sample container 60 is present in the target seat 151T, the controller may issue an alert to the user and report the error prior to beginning or continuing a run. In some embodiments, the controller 50 programmatically and automatically processes the image data as discussed herein using a reference marker. In some embodiments, the controller 50 programmatically and automatically processes the image data to identify a missing sample container as discussed herein before attempting to withdraw a sample from the target location in the carrier.

While the probe 124 is described above serving as the reference marker, other components may be used as the reference marker in other embodiments. For example, the system 10 may further include a dedicated reference marker that is inserted into the target seat volume at the same time as or before the probe 124.

In some embodiments, the probe portion 124A is provided with indicium, marks, a visibly contrasting sleeve, or other features to enhance its identifiability in the image data.

The foregoing method may be particularly beneficial when monitoring sample containers that are translucent. As used herein, “translucent” means that the portion of the sample container (e.g., a section of the side wall 63) through which the probe portion is visible to the barcode reader 172 is not fully opaque or transparent, but instead partially transmits the incident light (reflected from the probe portion). However, some of the incident light is reflected, absorbed, diffracted and/or scattered so that the transmitted light is reduced and/or diffused by the sample container material. As a result, the visible image of the probe portion is dimmed and/or made less distinct (e.g., more fuzzy) by the sample container side wall.

A translucent sample container may transmit a sufficient amount of light that the translucent sample container does not appear (in the acquired image) sufficiently distinct from an empty volume. In such cases, the controller may incorrectly determine that the target seat does not contain a sample container. The method employing a reference marker can enable the controller to more positively, reliably, or accurately determine that the target seat is or is not occupied.

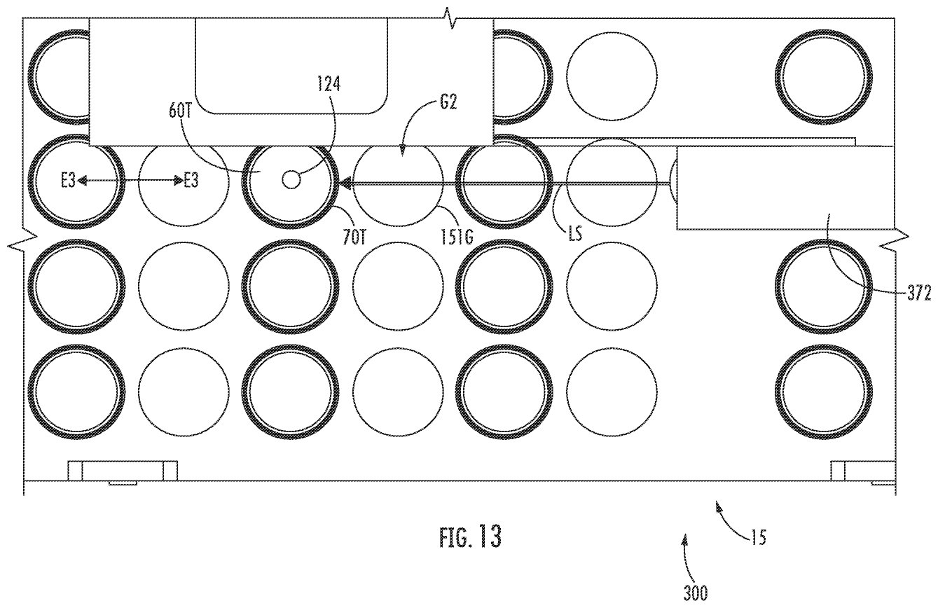

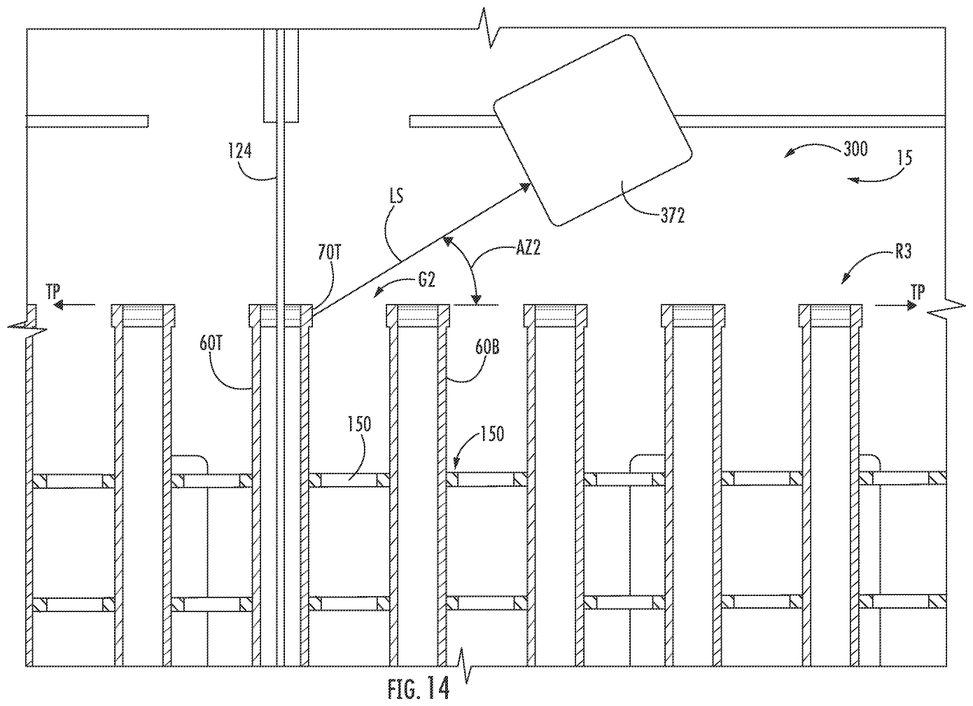

According to some embodiments, when the barcode reader is in its reading position with respect to a given target sample container 60, the line of sight LS (which intersects the barcode 70T of the target sample container 60T) extends through a gap between the selected target sample container and an adjacent sample container in the row that includes the target sample container. For example, with reference to FIGS. 13 and 14, a sample analyzer system 15 and autosampler 300 according to further embodiments is shown therein. The system 15 and autosampler 300 may be constructed and operated in the same manner as the system 10 and autosampler 100, except as follows.

The illustrated autosampler 300 is configured such that, when the barcode reader 372 is in its reading position with respect to a target sample container 60T, the line of sight LS of the barcode reader 372 is vertically offset from the sample container top plane TP-TP by an oblique vertical offset angle AZ2. However, the line of sight plane PL-PL of the barcode reader 372 is not laterally offset from the row axis E3-E3 of the row R3 including the target sample container 60T. An adjacent sample container 60B is also located in the row R3. The line of sight LS extends at an oblique vertical offset angle AZ2 with respect to the sample container top plane TP-TP and through a void or gap G2 defined between the target sample container 60T and the adjacent sample container 60B. In some embodiments and as shown, the gap G2 is located over a seat 151G of the carrier 150 that does not contain a sample container 60 (i.e., an empty seat). In some embodiments, the carrier 150 may be constructed or the sampled containers 60 otherwise positioned such that gaps between sample containers in the same row are provided without leaving seats empty.

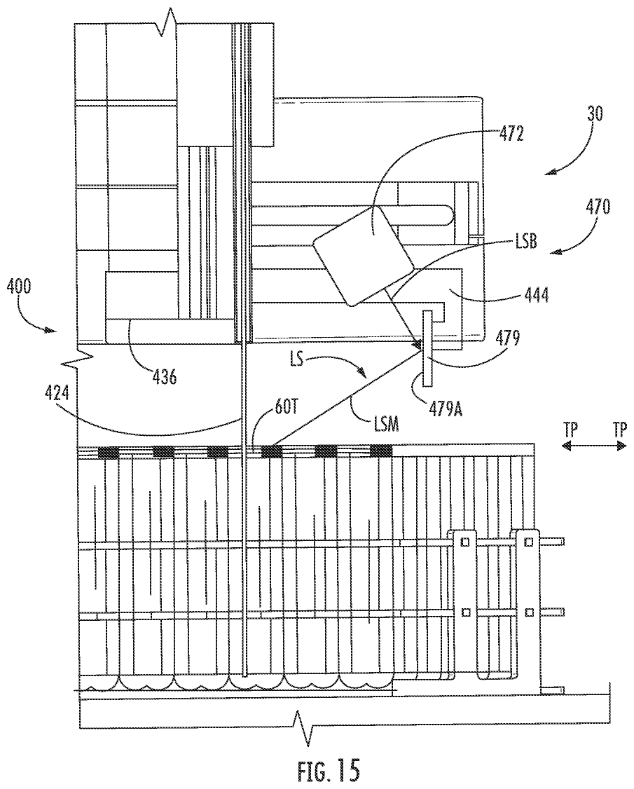

With reference to FIG. 15, according to further embodiments, shown is a sample analyzer system 30 including an autosampler 400 that includes a monitoring system 470. The sample analyzer system 30 may be constructed and operated in the same manner as the sample analyzer system 10, except as follows. The sample analyzer system 30 includes a probe 424 corresponding to the probe 124. The sample analyzer system 30 further includes a mirror 479 mounted on the mount arm 444. The mount arm 444 is mounted on a Y-axis arm 436 (corresponding to the arm 136) for movement therewith. The barcode reader 472 is relocated and mounted on the arm 444 above the height of the mirror 479. The line of sight LS of the barcode reader 472 is directed at and reflected by a reflecting surface 479A of the mirror 479. The line of sight LS includes a first segment LSB extending from the barcode reader 472 to the mirror 479, and a second segment LSM extending from the mirror 479 to the barcode indicium of the target sample container 60T. The segment LSM of the barcode reader line of sight LS extending from the mirror 479 to the target sample container 60T is oriented with respect to the sample containers 60, the top plane TP-TP, and the row axis in the same manner as described above for the line of sight LS. Accordingly, the monitoring system 470 will operate and provide the same benefits as discussed above for the monitoring system 170. The mirror 479 of the monitoring system 470 may enable the designer (and system) to use a wider range of angles for reading the barcodes on the target sample container and/or the carrier, and/or for using machine vision as discussed above. The mirror 479 may also allow for more flexible (e.g., desirable) placement or packaging of the barcode or other type of reader.

While the autosamplers 100, 300, 400 are shown and described with carriers having seats (e.g., seats 151) and rows of sample containers arranged in substantially rectilinear side-by-side row arrays, the carrier seats and sample containers may be otherwise arranged with the autosampler (and, in particular, the sample container monitoring system, e.g., systems 170, 470) configured and operating as described for the autosamplers 100, 300, 400. For example, in some embodiments, an autosampler including a sample container monitoring system as described herein includes a carrier having seats and holding sample containers that are arranged in arcuate or circular side-by-side (e.g., concentric) rows.

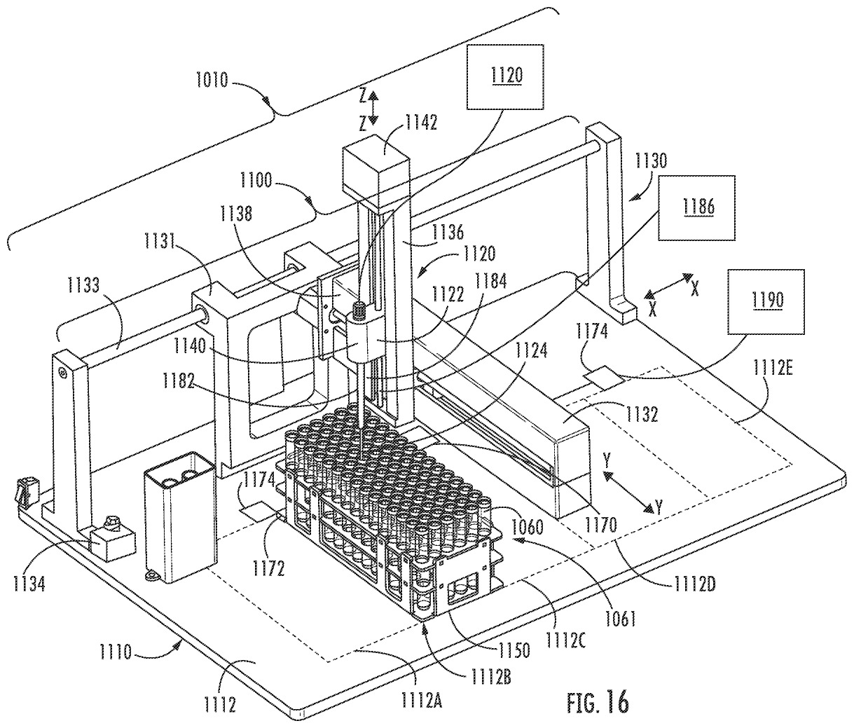

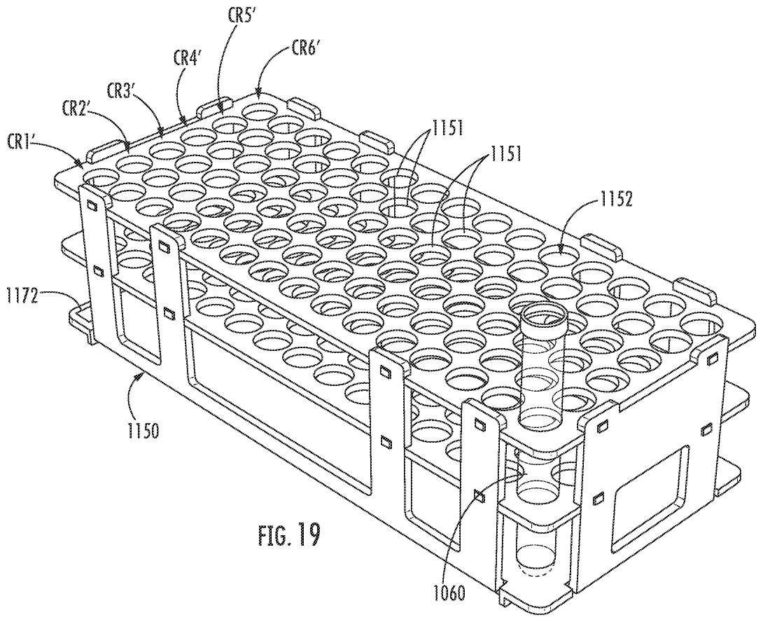

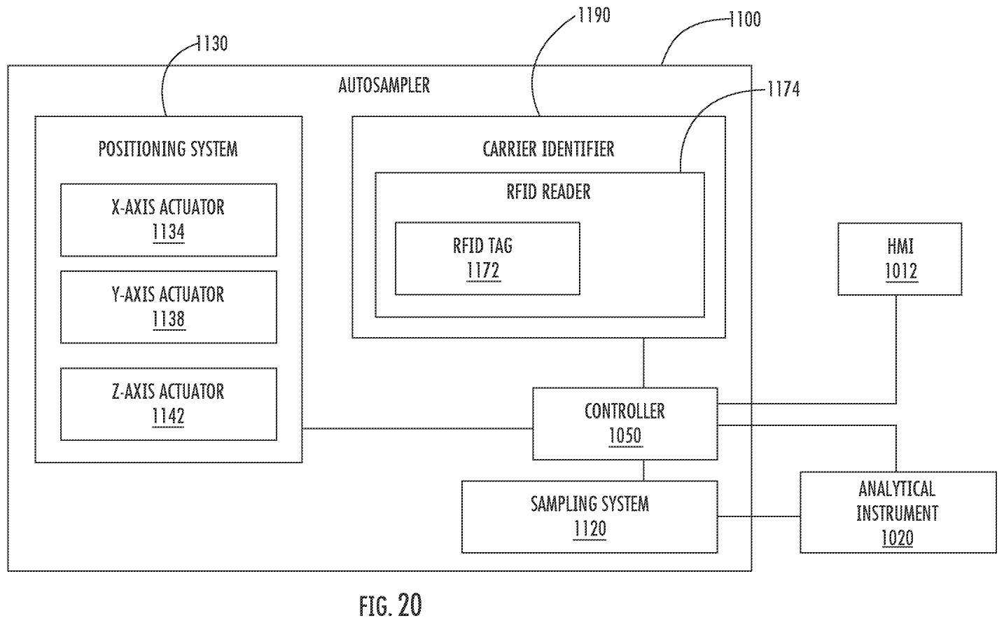

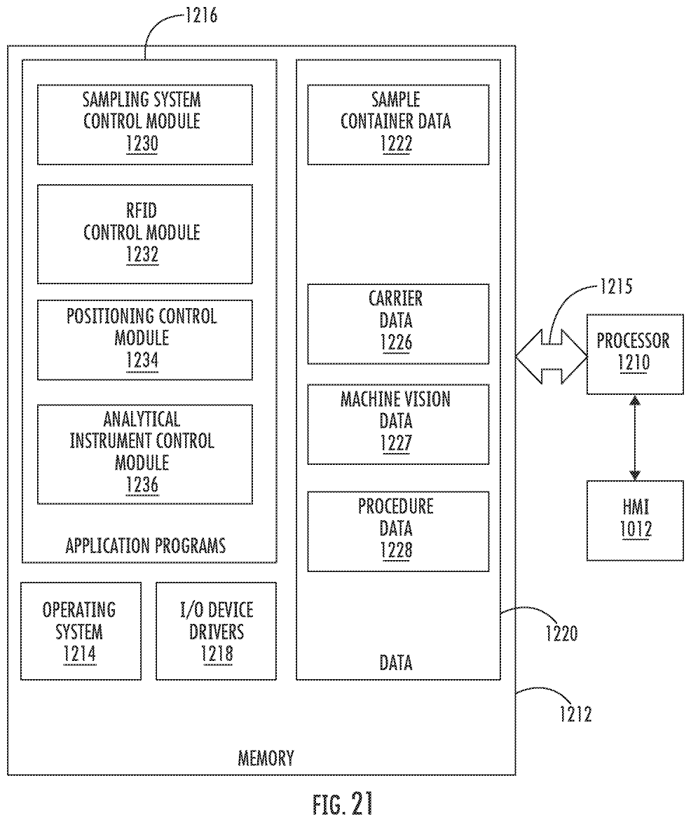

With reference to FIGS. 16-21, a sample analyzer system 1010 according to some embodiments of the technology is shown. The sample analyzer system 1010 includes an automated sampler device or autosampler 1100, an analytical instrument 1020, a controller 1050, and a plurality of sample containers 1060. The system 1010 may include a human-machine interface (HMI) 1012 (FIGS. 20-21) such as a display with a touchscreen. According to embodiments of the technology, the autosampler 1000 is configured and used to supply samples from the sample containers 1060 to the analytical instrument 1020. For example, in some embodiments, the autosampler 1100 automatically and programmatically supplies samples from the sample containers 1060 to the analytical instrument 1020, and the analytical instrument 1020 serially processes the supplied samples.

The analytical instrument 1020 may be any suitable apparatus for processing a sample or samples. The analytical instrument 1020 may include one or more of systems for analyzing a sample in a container such as a tube, including but not limited to an atomic absorber, an inductively coupled plasma (ICP) instrument, a gas chromatography system, a liquid chromatography system, a mass spectrometer, a thermal measurement instrument such as a calorimeter or thermogravimetric analyzer, a food (e.g., grain, dough, flour, meat, milk, etc.) analyzer, or combinations of any of the foregoing, for example.

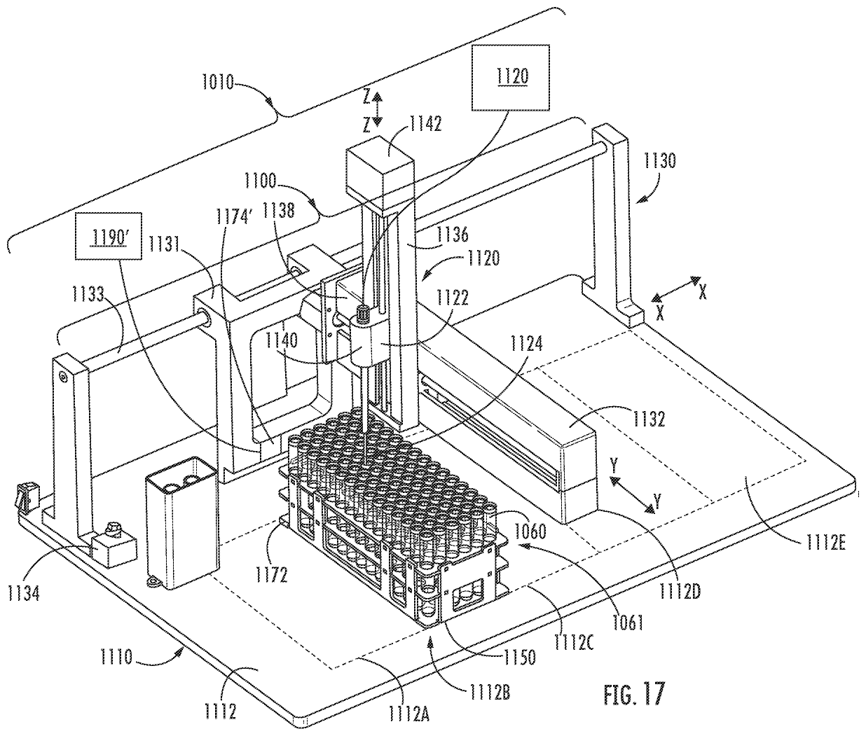

The autosampler 1100 includes a support frame 1110, an extraction or sampling system 1120, a positioning system 1130, a carrier identification system (FIGS. 16-17), one or more carriers 1150, and a plurality of the sample containers 1060.

The frame 1110 includes a deck or platform 1112. In use, the carrier 1150 is mounted on the platform 1112. In some embodiments, the carrier 1150 may be a discrete component that is conveniently removable from the platform 1112. The platform 1112 defines carrier positions 1112A-1112E. The carrier positions 1112A-1112E may be marked by indicia such as a marking, e.g., an outline marking or position marker that guides the user to position the carrier 1150 at one of the carrier positions 1112A-1112E. In some embodiments, the carrier positions 1112A-1112E may include a physical feature or features, such as a recess, protrusion or wall that abuts the carrier 1150 and defines the carrier positions 1112A-1112E and/or prevents the carrier 1150 from being positioned outside, backwards, or misaligned with the carrier positions 1112-1112E where the carrier 1150 is positioned. Each carrier is generally marked by sample position number (1-n); therefore, if the user places the sample carrier on the platform 1112 in an incorrect orientation, the sampling sequence may be incorrect (e.g., sample n may be aspirated first and sample 1 may be aspirated last if the sample carrier is backwards). It should be understood that any suitable number of carrier positions may be used. A plurality of sample carriers 1150 each loaded with sample containers 1060 may be mounted on the platform 1112 and accessed by the autosampler 1100 as described herein. The plurality of sample carriers 1150 may have different configurations of sample containers 1060, such as a various numbers of containers, various spacing between containers, or various sizes of containers.

The sampling system 1120 includes a sampling head 1122. The sampling head 1122 includes a probe 1124. The sampling head 1122 may be a syringe and the probe 1124 may be a needle, for example.

The positioning system 1130 includes a support rail 1133, a frame 1131, a first arm 1132, an X-axis actuator 1134, a second arm 1136, a Y-axis actuator 1138, a shuttle or carriage 1140, and a Z-axis actuator 1142.

The first arm 1132 is mounted on the rail 1133. The first arm 1132 can be selectively translated relative to the rail 1133 (and the platform 1112) in opposed directions (e.g., left and right) along a first axis X-X by the X-axis actuator 1134.

The second arm 1136 is mounted on the first arm 1132. The second arm 136 can be selectively translated relative to the first arm 1132 (and the platform 1112) in opposed directions (e.g., in and out) along a second axis Y-Y by the Y-axis actuator 1138. The Y-axis actuator 1138 may be a linear actuator.

The carriage 1140 is mounted on the second arm 1136. The carriage 1140 can be selectively translated relative to the second arm 1136 (and the platform 1112) in opposed directions (e.g., up and down) along a third axis Z-Z by the Z-axis actuator 1142.

The sampling head 1122 is mounted on the carriage 1140 for movement therewith. It will be appreciated that the sampling head 1122 (and tip of the probe 1124) can be selectively positioned and repositioned in three dimensional space (along the X-, Y- and Z-axes) as desired using the actuators 1134, 1138, 1142.

The controller 1050 (FIG. 20) may be any suitable device or devices for providing the functionality described herein. The controller 1050 may include a plurality of discrete controllers that cooperate and/or independently execute the functions described herein. The controller 1050 may include a microprocessor-based device, including, for example, a computer, tablet or smartphone.

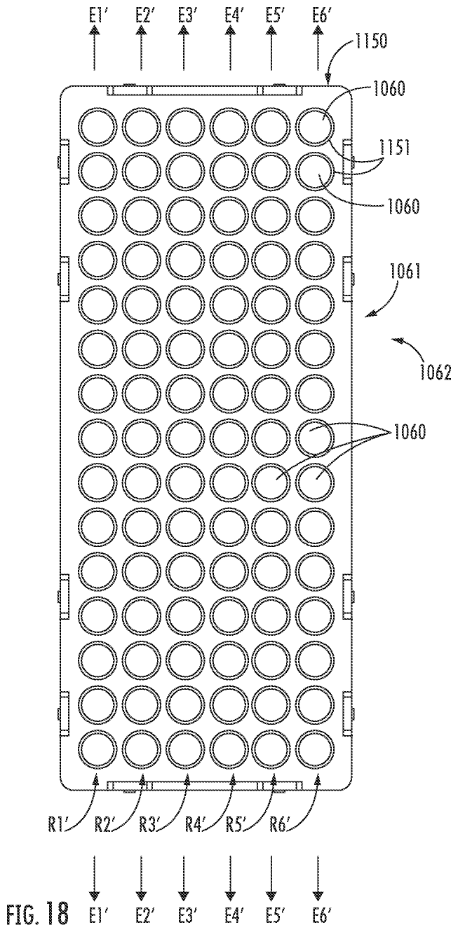

The carrier 1150 may be a platter, tray, rack or the like. The carrier 1150 may be configured to be stably mounted on the platform 1112, for example, in the carrier positions 1112A-1112E. In some embodiments, a recess or protrusion may abut the outer perimeter of the carrier 1150 so that the user can more easily ascertain that the carrier 1150 is within the defined carrier positions 1112A-1112E. In some embodiments, a plurality of sample container seats 1151 (FIG. 18) are provided in the carrier 1150. Each seat 1151 includes one or more openings defining a bore, receptacle or slot 1152 sized to receive (from above), positively position, and releasably hold a respective sample container 1060.

The seats 1151 may be arranged in a prescribed configuration so that each seat 1151 has a prescribed location in the carrier 1150, and a sample container 1060 mounted in the seat 1151 has a corresponding prescribed location in the carrier 1150. In some embodiments, the seats 1151 are arranged in an array. In some embodiments, the seats 1151 are arranged in a two-dimensional array having substantially linear rows of seats 1151.

In some embodiments and as shown in FIG. 18, the carrier 1150 has a predetermined configuration that is determined by the arrangements of the seats 1151. As shown in FIG. 18, the seats 1151 are arranged in the carrier in an array including a plurality of side-by-side, linear rows R1′-R6′. Each row R1′-R6′ has a central axis. In some embodiments and as shown, the central axes of the rows R1′-R6′ are substantially parallel. In some embodiments, the rows R1′-R6′ are substantially straight with each seat being substantially centered on its row's central axis E1-E6. The sample containers 1060 are arranged in the carrier 1150 in an array 1062 including a plurality of side-by-side rows R1-R6 corresponding to carrier seat rows CR1-CR6, respectively.

The sample analyzer system 1010 can be used and operated as follows in accordance with methods of the present technology. The controller 1050, the actuators 1134, 1138, 1142, the sample identification system (FIGS. 16-17), the sampling system 1120, and the analytical instrument 1020 collectively serve as a control system operative to execute the methods.

As shown in the FIG. 16 embodiment, the sample identification system includes an RFID tag 1172 on the carrier 1150 and RFID readers 1174′ that are positioned adjacent or in proximity to corresponding carrier positions 1112A-1112E. The RFID tags 1172 and readers 1174 are passive RFID components such that the RFID tag 1172 on the carrier 1150 does not generally require a dedicated battery or power source; however, in some configurations, active RFID systems may be used. The RFID readers 1174 are in communication with carrier identifier 1190. In this configuration, each of the carrier positions 1112A-1112E includes a designated RFID reader 1174 such that when a carrier 1150 with an RFID tag 1172 is positioned adjacent one of the RFID readers 1174, the RFID reader 1174 activates the RFID tag 1172 to receive a signal from the RFID tag 1172.

The signal from the RFID tag 1172 may be conveyed to the carrier identifier 1190. The carrier identifier 1190 may determine in which one of the carrier positions 1112A-1112E the carrier 1150 has been placed based on which RFID reader 1174 is sending the signal. In addition, the signal may include information regarding the configuration of the carrier 1150, including a number and arrangement of sample containers 1060.

The carrier identifier 1190 may provide information regarding the configuration and/or location of the carrier 1150 from the RFID tag 1172 to the controller for controlling the sampling system 1120, the positioning system 1130, and the analytical instrument 1020. The carrier identifier 1190 may provide information regarding the configuration and/or location of the carrier 1150 to the HMI 1012, which can display the information to the user so that the user can confirm the information and correct any errors.

Generally, when it is desired to analyze the sample in a selected one of the sample containers 1060 (referred to herein as the “target sample container”), the controller 1050 operates the actuator 1134 to reposition the arm 1132 along the X-axis, and operates the actuator 1138 to reposition the arm 1136 along the Y-axis such that the probe 1124 is positioned directly over the target sample container 1060. The controller 1050 then operates the actuator 1142 to lower the carriage 1140 along the Z-axis. The probe tip 1125 is thereby lowered into the target sample container 1060. The controller 1050 then operates the sampling system 1120 to withdraw a sample N from the chamber 1064 of the target container 1060 and transfer the sample to the analytical instrument 1020.

The controller 1050 then operates the actuator 1142 to raise the carriage 1140 along the Z-axis and thereby remove the probe 1124 from the target sample container 60. The controller 1050 can thereafter repeat the foregoing procedure to withdraw samples from other selected sample containers 1060 in the carrier 1150.

Accordingly, the controller 1050 may utilize the configuration of the carrier 1150 that is received from the carrier identifier 1190 based on information from the signal of the RFID reader 1174 to identify the configuration of the carrier 1150. The controller 1050 may then execute an appropriate action depending on the acquired data from the RFID reader 1174.

The sampling system of the disclosed autosampler may be configured to extract or withdraw samples from the sample containers 1060 in any suitable manner. In some embodiments, the sampling system withdraws the sample from the sample container while the sample container is disposed in the carrier. In some embodiments, the sampling system (e.g., the sampling system 1120) includes a probe 1124 that is inserted into the sample container 1060 and a negative pressure is induced in the probe to aspirate the sample into the probe. The aspirated sample may then be transferred to an inlet of the analytical instrument from the probe. For example, the aspirated sample may be transferred through a conduit between an outlet of the probe and an inlet of the analytical instrument. Alternatively, the probe may be inserted into an inlet (e.g., an injection port) of the analytical instrument and the sample then dispensed from the probe into the inlet. In further embodiments, the probe (e.g., a pin probe) may be inserted into and removed from the sample container such that a droplet of the sample adheres to the probe, and the probe is then moved to an inlet of the analytical instrument to deposit the droplet.

In some embodiments, the sample container is removed from the carrier and transferred to another location or withdrawal station, where the sampling system then withdraws the sample from the sample container. In this case, the withdrawal station may be a part of the analytical instrument or a supplemental station. For example, in some embodiments, the sample container is transferred (e.g., by a robotic end effector) to a withdrawal station where a probe aspirates or otherwise removes a sample from the sample container, and then transfers the sample to the analytical instrument as described above (e.g., via a conduit or injection port). In some embodiments, the withdrawal station may withdraw the sample from the sample container without a probe (e.g., by flowing a carrier gas through the sample container (e.g., a thermal desorption tube)).

Operations described herein can be executed by or through the controller 1050. The actuators 1134, 1138, 1142 and other devices of the system 1010 can be electronically controlled. According to some embodiments, the controller 1050 programmatically executes some, and in some embodiments all, of the actions or operations described. According to some embodiments, the movements of the actuators are fully automatically and programmatically executed by the controller 1050.

Embodiments of the controller 1050 logic may take the form of an entirely software embodiment or an embodiment combining software and hardware aspects, all generally referred to herein as a “circuit” or “module.” In some embodiments, the circuits include both software and hardware and the software is configured to work with specific hardware with known physical attributes and/or configurations. Furthermore, controller logic may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or other storage devices.

FIG. 21 is a schematic illustration of a circuit or data processing system 202 that can be used in the controller 1050. The circuits and/or data processing systems may be incorporated in a digital signal processor 1210 in any suitable device or devices. The processor 1210 communicates with the HMI 1012 and memory 1212 via an address/data bus 1215. The processor 1210 can be any commercially available or custom microprocessor. The memory 1212 is representative of the overall hierarchy of memory devices containing the software and data used to implement the functionality of the data processing system. The memory 1212 can include, but is not limited to, the following types of devices: cache, ROM, PROM, EPROM, EEPROM, flash memory, SRAM, and DRAM.

FIG. 21 illustrates that the memory 1212 may include several categories of software and data used in the data processing system: the operating system 1214; the application programs 1216; the input/output (I/O) device drivers 1218; and data 1220.

The data 1220 can include equipment-specific data. FIG. 21 also illustrates that the data 1220 can include sample container data 1222, carrier data 1226, machine vision data 1227, and procedure data 1228. The sample container data 1222 can include data relating to or representing characteristics of each sample container 1060, including a unique identifier (e.g., serial number), name, and description of an analyte contained in the sample container 1060, for example. The carrier data 1226 can include a registry indexing or cross-referencing carrier configurations to the carrier signals received from the RFID readers 1174. The carrier data 1226 can include seat location data representing spatial or geometric layout or positions of the seats 1151 relative to the carrier 1150 and the frame 1110. The machine vision data 1227 can include algorithms, reference images, and other data to assist in interpreting the image data. The procedure data 1228 can include data representing a protocol or sequence of actions or operations to execute the procedures described herein (including an analytical sequence, for example).

FIG. 21 also illustrates that application programs 1216 can include a sampling system control module 1230 (to control the sampling system 1120), and RFID control module 1232 (to control the carrier identification system (including the RFID reader 1174)), a positioning control module 1234 (to control the actuators 1134, 1138, 1142), and an analytical instrument control module 1236 to control the analytical instrument 1020.

As will be appreciated by those of skill in the art, the operating system 1214 may be any operating system suitable for use with a data processing system. The I/O device drivers 1218 typically include software routines accessed through the operating system 1214 by the application programs 1216 to communicate with devices such as I/O data port(s), data storage and certain memory components. The application programs 1216 are illustrative of the programs that implement the various features of the data processing system and can include at least one application, which supports operations according to embodiments of the present technology. Finally, the data 1220 represents the static and dynamic data used by the application programs 1216, the operating system 1214, the I/O device drivers 1218, and other software programs that may reside in the memory 1212.

As will be appreciated by those of skill in the art, other configurations may also be utilized while still benefiting from the teachings of the present technology. For example, one or more of the modules may be incorporated into the operating system, the I/O device drivers or other such logical division of the data processing system. Thus, the present technology should not be construed as limited to the configuration of FIG. 21, which is intended to encompass any configuration capable of carrying out the operations described herein. Further, one or more of the modules can communicate with or be incorporated totally or partially in other components, such as the controller 1050.

It should be understood that any suitable configuration of RFID tag and/or reader may be used. For example, as illustrated in FIG. 17, a sample identification system includes an RFID tag 1172 on the carrier 1150 and RFID reader 1174′ that is positioned on the frame 1131 of the positioning system 1130. The RFID reader 1174′ provide a signal from the RFID tag 1172 to the carrier identifier 1190′. In this configuration, a single RFID reader 1174′ may be moved along the X-axis to any of the carrier positions 1112A-1112E to determine if an RFID tag 1172 from a carrier 1150 is present and/or to receive information encoded in a signal regarding the configuration of the carrier 1150. The carrier identifier 1190′ may receive the position of the RFID reader 1174′ from the positioning system 1130 to determine at which location (i.e., at which one of the carrier positions 1112A-1112E) the RFID reader 1174′ is located when a signal is received. As illustrated, the positioning system 1130 provides scanning functionality for the RFID reader 1174′ to be moved along possible positions of the carriers 1150. However, any suitable scanning unit may be used to move the RFID reader 1174′ to various positions on the platform 1112 to receive a signal from a tag 1172 on the carrier. In this configuration, only one RFID reader 1174′ may be used to detect a signal at more than one location.

It should be further understood that any suitable configuration of carrier may be used, including various carrier shapes.

In some embodiments, the RFID tag may be configured to provide additional information and/or functions. For example, passive RFID transponder(s) or tag(s)s may include temperature sensors that are powered by the RFID transponder or reader when queried by the RFID reader such that a temperature measurement is made when the RFID reader reads the RFID tag. In this configuration, the temperature of the sample carrier may be measured so that temperature control (cooling or heating) of the trays may be measured. Temperature sensing RFID tags are available, for example, from Phase IV Engineering, Inc. (Boulder, Colo., USA).

Additional data from that autosampler may further be used and correlated with data from the RFID tag and reader, including the sensor data. For example, autosamplers that utilize barcode readers, machine vision, user inputs via an HMI or other data gathering devices may correlate data from multiple sources to identify sample carriers, track temperature, and the like.

It should be understood that any suitable configuration of RFID tag and/or reader may be used, and RFID tags and readers may be positioned in other locations on the autosampler and/or sample carrier. For example, as shown in FIG. 16, an RFID tag 1182 is mounted on the syringe 1122 and an antenna PCB or RFID reader 1184 is mounted on the autosampler. The RFID reader 1184 is in communication with a syringe monitor 1186 for receiving, storing and analyzing data from the RFID reader 1184 and tag 1182. For example, in some embodiments, the RFID reader 1184 connects to a transceiver card, which connects to the controller or syringe monitor 1186, such as by a coax cable to allow movement of the syringe 1122.

Although embodiments according to the present invention are described herein with respect to RFID tags and readers, it should be understood that other devices may be used for collecting information and/or identifying a position and/or configuration of a sample carrier or syringe, including but not limited to, a barcode reader for reading a barcode on the carrier or syringe, magnets with reed switches, and electrical grounding techniques.

Therefore, in some embodiments, the RFID tag 1182 includes additional information. For example, the RFID tag 1182 may provide sensing capability, including temperature sensing. Thus, the RFID tag 1182 may include a separate sensor, such as a temperature sensor, such as for sensing the temperature of the syringe 1122. In some embodiments, the RFID tag 1182 is relatively large to accommodate the temperature sensor and may be a curved shape to fit in closer contact with the syringe 1122.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. An autosampler comprising:
a carrier for receiving a plurality of sample containers, the sample containers each having a top end and a visible indicium;
wherein:
the top ends of the sample containers define a top plane; and
the visible indicia are located below the top plane;
an optical sensor configured to read the visible indicia and to generate an output signal corresponding thereto, the optical sensor having a line of sight;
a controller configured to receive the output signal; and
a sampling system to withdraw a sample from at least one of the sample containers;
wherein the autosampler is operative to move the optical sensor and/or the carrier relative to the other such that the line of sight intersects the visible indicium of a selected one of the sample containers, wherein the line of sight extends:
downward from a height above the height of the top plane;
at an oblique angle to the top plane; and
through a gap between the selected sample container and an adjacent sample container.

2. The autosampler of claim 1 wherein:
the carrier includes a plurality of seats; and
the sample containers are disposed in respective ones of the seats.

3. The autosampler of claim 1 wherein the visible indicium of each sample container is located on a sidewall of a top portion of the sample container.

4. The autosampler of claim 1 wherein the oblique angle defined between the line of sight and the top plane is in a range of from about 30 to 60 degrees.

5. The autosampler of claim 1 wherein the sample containers are configured in the carrier in an array including rows of the sample containers, and the rows each define a respective row axis.

6. The autosampler of claim 5 wherein:
the line of sight intersecting the visible indicium of the selected sample container lies in a line of sight plane that is orthogonal to the top plane; and
the autosampler is operative to move the optical sensor and/or the carrier relative to the other such that:
the row axis of the row including the selected sample container extends at an oblique angle to the line of sight plane; and
the line of sight intersecting the visible indicium of the selected sample container extends through a gap between the selected sample container and an adjacent sample container located in a row adjacent the row including the selected sample container.

7. The autosampler of claim 6 wherein the oblique angle defined between the row axis of the row including the selected sample container and the line of sight plane is in a range of from about 30 to 60 degrees.

8. The autosampler of claim 6 wherein the autosampler is operative to move the optical sensor and/or the carrier relative to the other such that the line of sight intersecting the visible indicium of the selected sample container extends through a gap between the selected sample container and an adjacent sample container located in a row adjacent the row including the selected sample container.

9. The autosampler of claim 5 wherein the autosampler is operative to move the optical sensor and/or the carrier relative to the other such that the line of sight intersecting the visible indicium of the selected sample container extends through a gap between the selected sample container and an adjacent sample container located in the row including the selected sample container.

10. The autosampler of claim 9 wherein:
the carrier includes a plurality of seats;
the sample containers are disposed in respective ones of the seats; and
the gap is located over a seat in the row including the selected sample container that does not contain a sample container.

11. The autosampler of claim 1 wherein:
the sampling system includes a sampling probe configured to withdraw a sample from a sample container; and
the autosampler is operative to position the sampling probe over the sample container when the line of sight of the optical sensor intersects the visible indicium of the selected sample container.

12. The autosampler of claim 11 including a positioning system configured to move the optical sensor together with the sampling probe relative to the carrier.

13. The autosampler of claim 1 including a mirror, wherein the line of sight extends from the visible indicium on the selected sample container to the mirror, and the mirror is configured to reflect an image of the visible indicium on the selected sample container to the optical sensor.

14. The autosampler of claim 1 wherein the controller is configured to programmatically and automatically determine from an output signal of the optical sensor that a location in the carrier for holding a sample container does not contain a sample container.

15. The autosampler of claim 1 wherein the controller is configured to programmatically and automatically determine a type of the carrier from an output signal of the optical sensor.

16. The autosampler of claim 1 wherein the controller is configured to programmatically and automatically identify each of the visible indicia.

17. The autosampler of claim 1 wherein the visible indicia are barcodes.

18. The autosampler of claim 1 wherein each sample container includes multiple copies of the visible indicium distributed about a circumference of the sample container.

19. The autosampler of claim 1 wherein:
the autosampler includes a reference marker; and
the controller is operative to determine whether a sample container is present in a target container receiving region of the carrier by:
positioning the reference marker in the target container receiving region;
acquiring an image of the container receiving region with the reference marker disposed in the target container receiving region; and
determining from the acquired image whether the reference marker is obfuscated in the acquired image by a sample container disposed in the target container receiving region.

20. The autosampler of claim 19 wherein the reference marker is a sampling probe forming a part of the sampling system and configured to withdraw a sample from a sample container.

21. A method for sampling, the method comprising:
providing a plurality of sample containers each having a top end and a visible indicium;
providing an autosampler including:
a carrier holding the plurality of sample containers such that:
the top ends of the sample containers define a top plane; and
the visible indicia are located below the top plane;
an optical sensor configured to read the visible indicia and to generate an output signal corresponding thereto, the optical sensor having a line of sight;
a controller configured to receive the output signal; and
a sampling system to withdraw a sample from at least one of the sample containers;
using the autosampler, moving the optical sensor and/or the carrier relative to the other such that the line of sight intersects the visible indicium of a selected sample container, wherein the line of sight extends:
downward from a height above the height of the top plane;
at an oblique angle to the top plane; and
through a gap between the selected sample container and an adjacent sample container;
using the optical sensor, reading the visible indicia and generating an output signal corresponding thereto to the controller; and
withdrawing a sample from the selected sample container.

22. The method of claim 21, further comprising:
providing an analytical instrument; and
transferring the withdrawn sample to the analytical instrument.

23. The method of claim 21, wherein:
the sample containers are configured in the carrier in an array including rows of the sample containers, and the rows each define a respective row axis;
the line of sight intersecting the visible indicium of the selected sample container lies in a line of sight plane that is orthogonal to the top plane; and
the method includes, using the autosampler, moving the optical sensor and/or the carrier relative to the other such that:
the row axis of the row including the selected sample container extends at an oblique angle to the line of sight plane; and
the line of sight intersecting the visible indicium of the selected sample container extends through a gap between the selected sample container and an adjacent sample container located in a row adjacent the row including the selected sample container.

24. An optical reader system comprising:
a carrier for receiving a plurality of units, the units each having a top end and a visible indicium;
wherein:
the top ends of the units define a top plane; and
the visible indicia are located below the top plane;
an optical sensor configured to read the visible indicia and to generate an output signal corresponding thereto, the optical sensor having a line of sight; and
a controller configured to receive the output signal; and
wherein the optical reader system is operative to move the optical sensor and/or the carrier relative to the other such that the line of sight intersects the visible indicium of a selected one of the units, wherein the line of sight extends:
downward from a height above the height of the top plane;
at an oblique angle to the top plane; and
through a gap between the selected unit and an adjacent unit.

25.-47. (canceled)
